(19) United States
(12) Patent Application Publication
(10) Pub. No.: US 2025/0390857 A1
(43) Pub. Date: Dec. 25, 2025

(54) Resource Allocation Based on Media Content Engagement

(71) Applicant: Block, Inc., San Francisco, CA (US)

(72) Inventors: Robert Glenn Bonstein, Brooklyn, NY (US); Damian Franken Manning, Brooklyn, NY (US); John Funge, Palo Alto, CA (US); Thomas Jerde, San Francisco, CA (US)

(73) Assignee: Block, Inc., San Francisco, CA (US)

(21) Appl. No.: 18/627,658

(22) Filed: Apr. 5, 2024

(51) Int. Cl. G06Q 20/22

(52) U.S. Cl. CPC G06Q 20/22

(57) ABSTRACT

A technique for resource allocation estimation for media content items is described. In accordance with the described techniques engagement by a set of user accounts with respective media content items of at least one media content service provider system is obtained. The media content service provider system and/or a payment service system generates historical streaming data for the respective media content items based on the engagement of the set of user accounts. An estimated streaming count of a media content item over a time period based on the historical streaming data for the respective media content items is determined. An estimated resource allocation for the artist is determined based on the estimated streaming count and an advance of funds is facilitated based on the estimated resource allocation to an account of the artist during the time period.

### TECHNICAL FIELD

Media content service provider systems can be implemented as dedicated applications as well as web pages and enable entities to provide the media content for subsequent streaming by other entities. For example, an artist or a distributor can provide music or videos to the media content service provider system for streaming by users who visit or subscribe to the media content service provider system. An artist and/or one or more other entities that have a relationship with the artist may be allocated resources for the streaming or download of media content items on the media content service provider system.

### BRIEF DESCRIPTION OF THE DRAWINGS

Features of the present disclosure, its nature, and various advantages, will be more apparent upon consideration of the following detailed description, taken in conjunction with the accompanying drawings. In the figures, the left-most digit(s) of a reference number identifies the figure in which the reference number first appears. The use of the same reference numbers in different figures indicates similar or identical items or features. The drawings are not to scale.

FIG. 1 is a block diagram depicting a non-limiting example environment configured to implement resource allocation based on media content engagement in accordance with one or more implementations.

FIG. 2 is a block diagram depicting a non-limiting example environment showing resource allocation to an account in accordance with one or more implementations.

FIG. 3 is a block diagram depicting a non-limiting example environment showing a machine learning engine generating streaming data in accordance with one or more implementations.

FIG. 4 is an illustration depicting a non-limiting example implementation showing operation of media content service provider systems and a payment service system with a user and an artist as facilitating the resource allocation based on the media content engagement in accordance with one or more implementations.

FIG. 5 is an illustration depicting a non-limiting example implementation showing operation of media content service provider systems and a payment service system with multiple entities as facilitating the resource allocation based on the media content engagement in accordance with one or more implementations.

FIG. 6 is an illustration depicting a non-limiting example of a user interface configured to support display of resource allocations based on media content item engagement in accordance with one or more implementations.

FIG. 7 is an illustration depicting a non-limiting example of a user interface configured to support search of a media content item for display of resource allocation based on media content item engagement in accordance with one or more implementations.

FIG. 8 is an illustration depicting a non-limiting example of a user interface configured to support display of ranked media content item engagement in accordance with one or more implementations.

FIG. 9 is a non-limiting example of a system showing a determination to withdraw resources allocated to an account in accordance with one or more implementations.

FIG. 10 is a non-limiting example of a system showing a determination to withhold withdrawal of resources allocated to an account in accordance with one or more implementations.

FIG. 11 is a flow diagram depicting a step-by-step procedure in an example implementation of operations performable by a processing device for facilitating resource allocation to an account for media content item engagement in accordance with one or more implementations.

FIG. 12 is a flow diagram depicting a step-by-step procedure in an example implementation of operations performable by a processing device for determining whether to withdraw resources allocated to an account for media content item engagement in accordance with one or more implementations.

FIG. 13 is a non-limiting example illustrating an environment in which resource allocation based on media content item engagement techniques described herein are performed in accordance with one or more implementations.

FIG. 14 is a non-limiting example illustrating an environment in which resource allocation based on media content item engagement techniques described herein are performed in accordance with one or more implementations.

FIG. 15 is a non-limiting example illustrating an environment in which resource allocation based on media content item engagement techniques described herein are performed in accordance with one or more implementations.

### DETAILED DESCRIPTION

Disclosed methods and systems include one or more media content service provider systems, which obtain engagement data related to engagement of user accounts with respective media content items on the media content service provider systems and reserves or allocates resources to content creators of the media content items (e.g., based on engagement data). For example, the engagement data may include streaming data indicating a numerical quantity of streams for respective media content items, a geographic location of a user account streaming the respective media content items, a type of a user account streaming the respective media content items, or any other information and/or data that relates to streaming of a media content item. The media content service provider systems generate historical streaming data for the respective media content items using the engagement data. The media content service provider systems can predict a streaming count over a future time period using the historical streaming data for the media content items. For example, the media content service provider systems may implement machine learning techniques and/or other time-series forecasting techniques to predict the streaming count for media content items of an artist.

In accordance with the described techniques, one or more media content service provider systems can use data-driven triggers to detect an implicit or explicit request of resource allocation in real-time or near-real-time and to allocate or reserve resources accordingly. For example, in some implementations, the data driven triggers can be the predicted streaming count to determine a resource allocation for an artist over the future time period. In variations, the media content service provider systems predict a streaming count for media content items of the artist over a defined time period, where the defined time period may be seconds, minutes, hours, etc. in the future. Based on the predicted streaming count and historical resource allocation data for the artist, the media content service provider systems obtain an initial resource allocation.

In some examples, the media content service provider systems can apply a confidence level to the initial resource allocation to obtain a resource allocation for the artist over the time period. The media content service provider systems calculate a confidence interval using one or more data sets (e.g., data from the media content service provider systems related to the artist and/or the media content items, data from one or more social platforms related to the artist and/or the media content items, data that indicates additional resource allocation for the artist, data related to other artists, and/or other media content items meeting a similarity threshold to the artist, to name a few). The media content service providers systems select the confidence level for the artist from the confidence interval. In many conventional scenarios, resource allocations for media content engagement leverage a system in which a media content service providers system provides a label and/or distributor with resources (e.g., monetary funds, credit, etc.) for engagement with one or more media content items, and the label and/or distributor provide the artist of the media content item with at least a portion of the resources. Such conventional systems have a number of intermediaries such as distributors, labels, and other rights holders that implement computational resources and network transmissions as these entities receive shares of resource allocations from the media content service provider systems before the artist receives a resource allocation. The data-driven confidence interval enables resource allocations to be provided to the artist more efficiently than in conventional systems, by providing resources in near-real-time (e.g., the same day as streams occur) and without the processing and network transmissions of conventional systems that require other rights holders to receive resource allocations prior to the artist.

In one or more implementations, one or multiple media content service provider systems report a numerical quantity of streams, referred to as a streaming count, for respective media content items over a historical time period (e.g., for a previous day, for a previous week, for a previous month, etc.). The payment service system determines a resource allocation for the artist based on the streaming count, such as based on a prearranged allocations or other agreement between one or more entities (e.g., the artist, producers, distributors, songwriters, band members, record labels, etc.). In variations, a stream is associated with a user interaction with a media content item, including a partial and/or a full playback via a device over a network of a media content item. The payment service system can provide a resource allocation (e.g., a credit and/or a balance) to an account of the artist with the determined resource allocation and the quantity of streams. However, with conventional payment service systems, there is often a delay between when a user streams a media content item on the media content service provider systems and when a resource allocation is provided or credited to a balance of an account of an artist. For example, a balance of an account of an artist is credited with a resource allocation, also referred to as a payment, according to a periodicity, including weekly payments, monthly payments, or payments according to any other periodicity, even though users stream the media content items in real-time. In practice, artists may not be paid for streams for several months (e.g., six or more months).

When receiving periodic payments, rather than receiving payments in real-time, there is a payment delay or lag that results in network congestion and an increased use of computational resources, such as processing resources and/or memory resources. For example, the artist related to the media content item may cause a device to transmit and/or receive additional signaling, such as when an artist attempts to contact the media content service provider systems and/or a payment service system to request information regarding the status of a payment. The additional signaling results in increased processing and signaling overhead at the device of the artist, as well as at the media content service provider systems and/or the payment service system. Further, due to the payment delay, the artist may not have access to funds in real-time, which can result in the artist attempting to access funds that are not present in a corresponding account. That is, the artist may overdraft an account by attempting to execute a data transaction for a payment of a value that is greater than a value in the account. If the artist attempts to use funds that are not present in the payment account, then a payment service system may generate one or more messages to notify the artist, a merchant, an issuing financial institution, an acquiring financial institution, and/or other entities affiliated with the payment service system about the attempt to use the funds, resulting in inefficient use of computational resources due to increased signaling overhead and increased processing.

The techniques described herein relate to providing a resource allocation to an artist in real-time to reduce signaling between parties when the artist executes transactions utilizing resources of the artist according to media content engagement. The payment service system can credit an account of the user in real-time with at least a portion of the resource allocation. A user interface of a device of the artist can display the resource allocation credited to the account, where the artist may use a payment instrument to access the resource allocation. Thus, the artist can view a resource allocation in real-time or near-real-time. Accordingly, a delay between when an account of an artist is credited for streaming of media content items and when a user streams the media content items is eliminated. Eliminating the delay further eliminates or reduces inefficient use of processing resources and/or network congestion caused by artists requesting information regarding the status of a payment. Additionally, or alternatively, eliminating the delay further eliminates or reduces inefficient use of processing resources and/or network congestion caused by an artist attempting to use funds that are not present in a payment account (e.g., by reducing or eliminating communications between devices of the artist and another device or server hosting a payment service system).

In some examples, the payment service system receives a request to access a balance of an account (e.g., of the artist) and determines whether to approve withdrawal of a portion of the balance that includes the resource allocation, referred to as a virtual balance, by evaluating information related to the artist. For example, the payment service system can evaluate signals from the media content service provider systems (e.g., the historical streaming data), a calculated confidence level, and/or additional data to make the determination. The additional data can include data related to the artist or the media content item from the media content service provider systems (charting data, playlisting data, fan engagement data, etc.), data from one or more social platforms related to the artist and/or the media content item, additional resource allocation data for the artist, among other data. Additionally, or alternatively, the additional data can include a category of a purchase for an account, a frequency of purchases for the account, or how often a purchase withdraws from the virtual balance (e.g., where the stored balance is withdrawn prior to the virtual balance), among other data. The media content service provider systems and/or the payment service system can calculate the confidence level using a probabilistic model based on a variability of a time series history of resource allocation for an actual streaming count of a media content item and/or categories of artists (a duration the artist has been making music, what part of the world the artist is in, what music service the artist is popular on, what distributor or record label the artist uses, etc.).

In some examples, the payment service system communicates with devices of artists regarding updates to the virtual balance. A device can display an instance of a payment service application including an account balance, as well as an instance of a media content service provider system application for publishing and/or streaming a media content item. In variations, some, or all, of the functionalities of the payments service application are implemented by the media content service provider system application, or vice-versa. The media content service provider system application configures the device to determine historical streaming data and to provide the historical streaming data to the payment service application and/or configures the computing device to use the historical streaming data to predict the streaming count of the media content item.

A number of computational and network efficiencies are realized by implementing a single platform that monitors media content engagement and provides resource allocation according to the techniques described herein. For example, implementing a single platform that monitors media content engagement and provides resource allocation to an artist of the media content reduces use of computational resources that results from exchange of signaling between a platform that monitors media content engagement and a platform that provides resource allocation. The signaling can include an indication of streaming counts, among other engagement information, for media content items. Separate platforms transmitting and receiving the signaling use processing, power, and memory resources to transmit, monitor for, and decode the signaling, leading to an inefficient use of the resources when compared with a single platform that does not transmit signaling including the engagement information. Even in cases where a media content service provider system is independent of a payment service, the described techniques realize technical improvements in both computational resource consumption and network traffic by, for instance, exposing media content engagement directly to a payment service via an application programming interface (API) as opposed to conventional techniques that transmit such information through multiple entities (e.g., distributors, labels, etc.). That is, transmitting media content engagement to multiple entities leads to increased signaling overhead, power consumption, processing resources, and memory resources. An API providing media content engagement to a payment service for providing resource allocations to artists of media content eliminates transmission of the media content engagement to the multiple entities.

Although the techniques discussed herein are described in relation to “artists” and “users,” the techniques are applicable to other entities, such as to facilitate resource allocation for other entities. The other entities may be involved in creation, publishing, or distribution of the media content items on the media content service provider systems. Example entities for which the described media content service provider systems may be useful include but are not limited to producers, distributors, songwriters, record labels, actors and actresses, athletes, crafts people, personalities, businesspeople, academics, fitness personalities, merchandisers, chefs, restauranteurs, facility or venue owners/engines, fashion designers, influencers, models, and promoters, to name just a few.

The preceding summary is provided for summarizing some example embodiments to provide a basic understanding of aspects of the subject matter described herein. Accordingly, the above-described features are merely examples and should not be construed as limiting in any way. Other features, aspects, and advantages of the subject matter described herein will become apparent from the following description of the Figures and Claims.

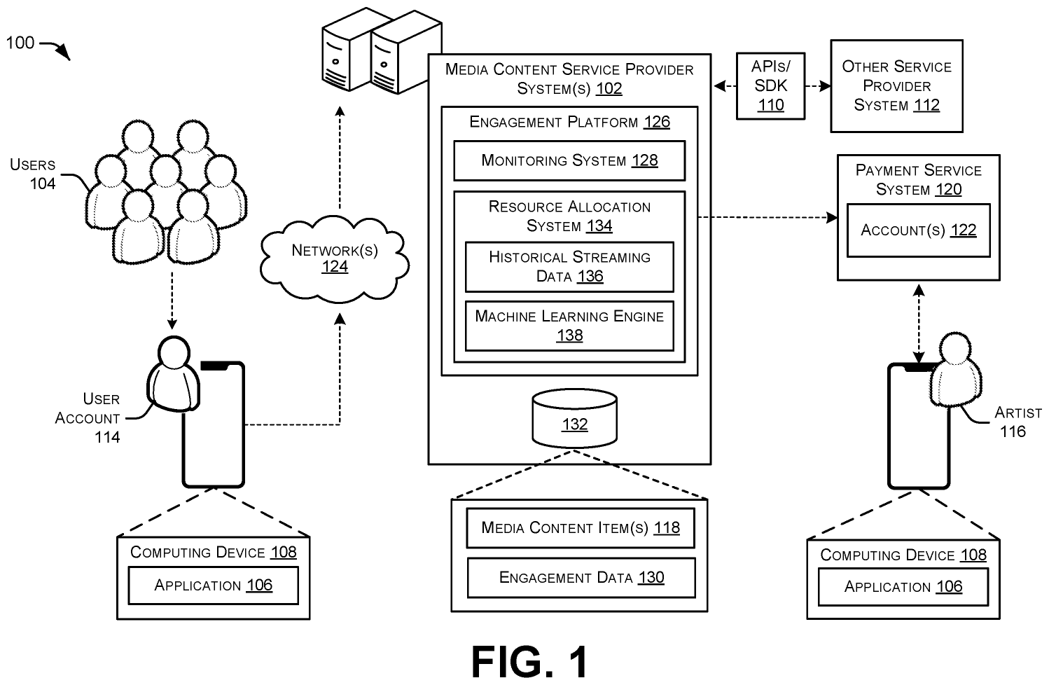

Referring to figures, FIG. 1 is a block diagram depicting a non-limiting example environment 100 configured to implement resource allocation based on media content engagement in accordance with one or more implementations. In one embodiment, the environment 100 includes one or more media content service provider systems 102 and a population of users 104 of the media content service provider systems 102. In one or more implementations, the media content service provider systems 102 are music service provider systems that, at least in part, provide media content (e.g., by accessing or playing media, such as by streaming music or streaming video) to a population of at least one of the users 104. For example, the media content service provider systems 102 are implemented by respective applications 106.

An application 106 can be a subscription-based digital media streaming application, which executes on a computing device 108. Example computing devices 108 include, but are not limited to, a mobile phone, a tablet, a computer, or other computing device. In some examples, media content is stored on a remote server, such as on a server implementing and/or associated with the media content service provider systems 102. In this way, the media content is either streamed offline (e.g., cached on the local computing device) or streamed online with content streaming in packets. Hence, the media content service provider systems 102 may be digital audio streaming services (e.g., for music and/or podcasts), digital video streaming services, or streaming services that provide streaming of various different types of digital media or multimedia. Such streaming services may be subscription-based, to provide for the users 104 to stream digital media content (e.g., songs, podcasts, and/or videos) on-demand from centralized libraries provided by the media content service provider systems 102.

Additionally, or alternatively, the media content service provider systems 102 are, or include, at least one application communicatively coupled, such as through dedicated application programming interfaces (APIs) or software development kits (SDKs) 110 to at least one other service provider system 112 that is, or deploys, one or more applications, such as a streaming application, content creation application, payment application, mapping application, loyalty application, social media application, generative artificial intelligence (AI) application, and so on.

The users 104 access the media content service provider systems 102 via one or more computing devices 108, which execute the application 106 as described herein. In at least one implementation, the users 104 have user accounts 114 with respective media content service provider systems 102, although in at least some cases, one or more of the users 104 have not signed up for user accounts 114 with the respective media content service provider systems 102. The user account 114 can include data related to a user 104, such as a user account name, a password, a geographical location, or region of the user 104, an age of a user 104, and/or one or more preferences of a user 104, among other data. In some examples, the media content service provider systems 102 support multiple different types of user accounts 114. The different types of user accounts 114 can include, but are not limited to, a paid user account in which a user 104 purchases respective subscriptions to the media content service provider systems 102 and an unpaid user account in which a user 104 accesses the media content service provider systems 102 without purchasing the respective subscriptions to the media content service provider systems 102.

In the illustrated example, a computing device 108 is depicted with the application 106. The computing device 108 is associated with a user account 114 of a media content service provider system 102 (e.g., where the user 104 may have a user account 114 for respective media content service provider systems 102). For example, the computing device 108 can run an application 106 that stores and/or implements the user account 114. Thus, one example user 104 of the media content service provider system 102 has the user account 114 with the media content service provider system 102 and accesses the media content service provider system 102 via the computing device 108 (e.g., using the application 106). By enabling user interaction with various user interfaces of the application 106, the computing device 108 provides the user 104 having the user account 114 with access to the various functionalities of the media content service provider system 102.

In one or more implementations, one or more users of the media content service provider systems 102 are designated as artists (e.g., the artist 116), which collectively form a population of artists. The artist 116 can also use a computing device 108 or interfaces to interact with the media content service provider systems 102 (e.g., via respective applications 106). The population of artists generate media content for the media content service provider systems 102, for other service providers (e.g., for one or more streaming services), for live performances, and/or for exposure to an audience in various ways. For example, an artist 116 can generate, or produce, media content items 118 including music tracks, music albums, music videos, podcasts, and/or other audio or video media content. As used herein, the term “media content” or “media content item” may refer to television program, on-demand media program, pay-per-view media program, broadcast media program (e.g., live broadcast television program), multicast media program (e.g., multicast television program), narrowcast media program (e.g., narrowcast video-on-demand program), advertisement, video, movie, audio program, radio program, video clip, audio clip, user-generated audio program, AI generated or assisted audio or video program, user-generated video program, or any other media program or audio-video program that may be played back by a media player and/or a mobile computing device for presentation to a user (e.g., a media program that a user may access and consume by way of a media program service). In various scenarios, an artist 116 may upload a media content item 118 to one or more media content service provider systems 102 (e.g., through a distributor service). One or more users 104 may interact with the media content service provider systems 102 to stream media content items 118, such as audio media content items and visual media content items, among other types of media content items 118. For example, a user 104 may interact with the media content service provider systems 102 to listen to a music track, listen to a podcast, view a video, or consume any other audio and/or visual media content items.

The media content service provider systems 102 coordinate with a payment service system 120 to provide resource allocation (e.g., royalties, advances, etc.) to an artist 116 for a user 104 streaming one or more media content items 118 via the media content service provider systems 102. The one or more other entities can include, but are not limited to, producers, distributors, songwriters, and record labels. Although the environment 100 illustrates a user 104 and an artist 116, one or more additional, or alternative, entities (producers, distributors, songwriters, record labels, etc.) may interact with the media content service provider systems 102 and/or other services and systems. The media content service provider systems 102 can be referred to as media content service provider systems with media content libraries. A media content library stores the media content items 118 produced by artists 116.

In various implementations, the artists 116 may interact with a payment service system 120, such as via the application 106. In some cases, both the media content service provider systems 102 and the payment service system 120 may be accessible via a single application 106. That is, the media content service provider systems 102 and the payment service system 120 may be integrated into a single application 106 or platform, such that a user may interact with the media content service provider systems 102 and the payment service system 120 using the application 106. In some other cases, the media content service provider systems 102 and the payment service system 120 may be accessible via different applications 106, where the applications 106 can exchange application data to provide for transfer of information from the media content service provider systems 102 to the payment service system 120, and vice-versa.

An artist 116 may interact with the payment service system 120 via a computing device 108. For example, the artist 116 may initialize an application 106 to access the payment service system 120, where the computing device 108 displays different instances of the application 106. A computing device 108 can receive user input indicating or triggering the initialization of the application 106 (e.g., a request to open the application 106), and the computing device 108 can display a prompt to the artist 116 to provide for the artist 116 to input one or more credentials for an account 122 of the payment service system 120. The credentials can include a username and a password for the account 122. The account 122 can include data related to an artist 116, such as a username, a password, a geographical location, or region of the artist 116, an age of an artist 116, and/or one or more preferences of an artist 116, among other data. In some variations, such as if the payment service system 120 and the media content service provider systems 102 are implemented at a common application 106, the account 122 may be the same as or may have the same credentials as the user account 114, where the artist 116 is considered a user 104. In some other variations, such as if the payment service system 120 and the media content service provider systems 102 are implemented at separate applications 106, the account 122 may be different from the user account 114. For example, a user 104 may have one or more first accounts (e.g., respective user accounts 114) to access the media content service provider systems 102 and/or a second account to access the payment service system 120 (e.g., the account 122).

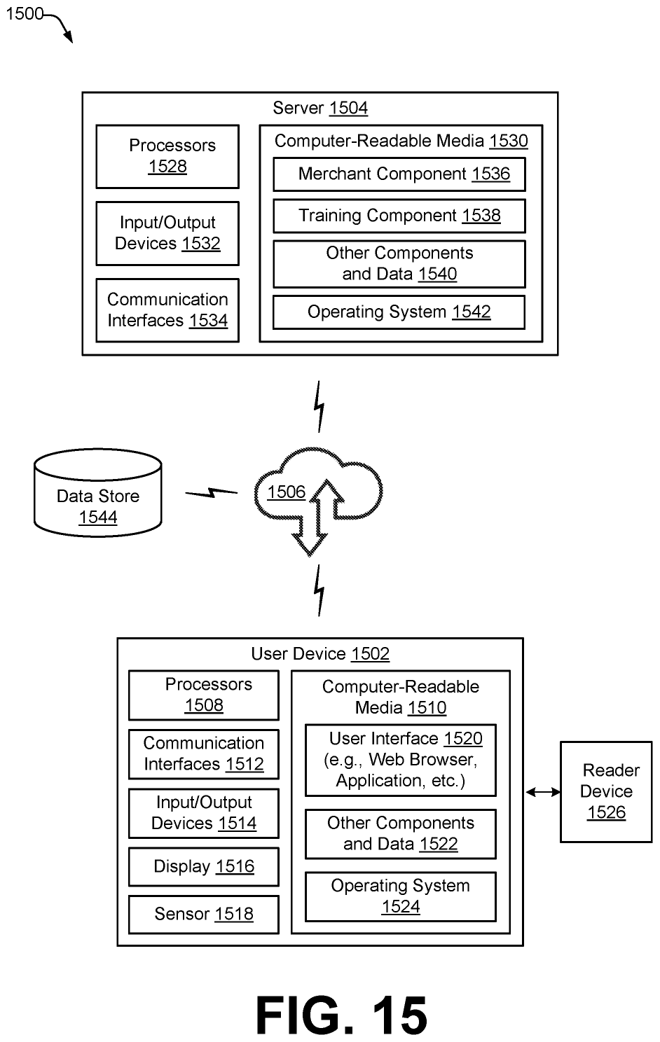

In one or more implementations, the media content service provider systems 102, the payment service system 120, the computing device 108 of the user 104, and the computing device 108 of the artist 116, are connected via one or more network(s) 124, examples of which include the Internet and cellular networks. Computing devices 108 that implement the environment 100 are configurable in a variety of ways. A computing device 108, for instance, is configurable as a server, a desktop computer, a laptop computer, a mobile device (e.g., assuming a handheld configuration such as a tablet or mobile phone), an IoT device, a wearable device (e.g., a smart watch), an AR/VR device, and so forth. Thus, a computing device 108 ranges from full resource devices with substantial memory and processor resources to low-resource devices with limited memory and/or processing resources. Although in instances in the following discussion reference is made to a computing device 108 in the singular, a computing device 108 may also represent any number of different computing devices 108, such as multiple servers of a server farm utilized to perform operations “over the cloud” as further described in relation to FIG. 15.

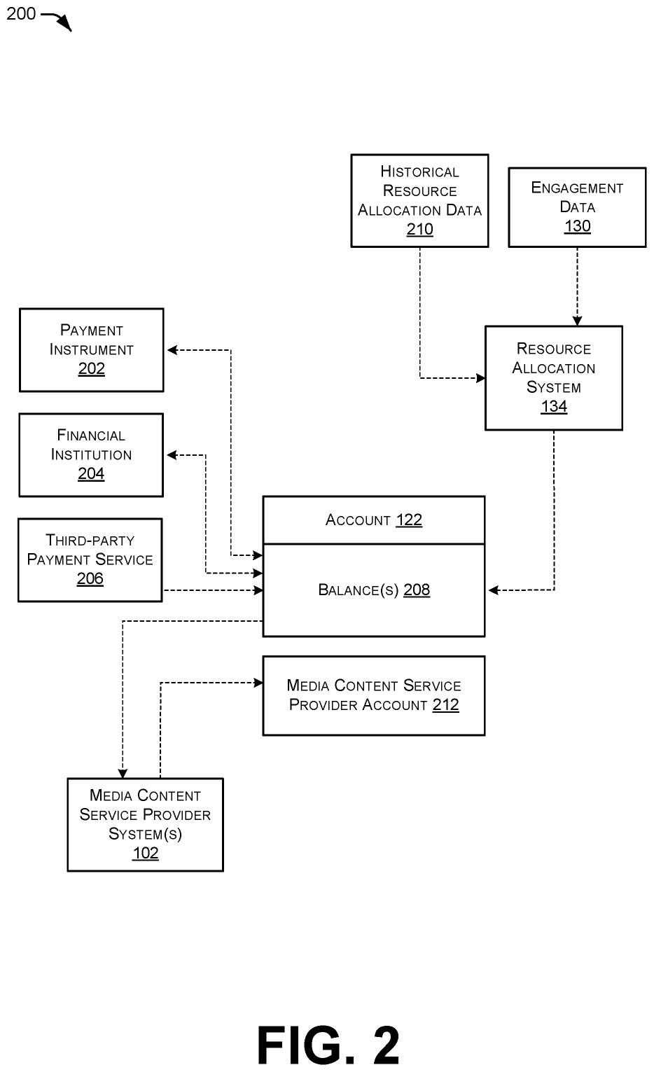

In some examples, the payment service system 120 can manage one or more balances for respective accounts 122. A balance of an account 122 can include a monetary value (e.g., cash, cryptocurrency, or other monetary value) credited or provided to a user of the account 122. Example users of the account 122 include, but are not limited to, the artist 116, a producer, a distributor, a songwriter, and a record label. A user of the account 122 accesses the balance to withdraw from the balance and/or credit the balance via one or more payment instruments, which is described in further detail with respect to FIG. 2. Example payment instruments include, but are not limited to, physical payment instruments and virtual payment instruments provided to the user by the payment service system 120 or another payment service (e.g., a bank or other financial institution, among other payment services). That is, a payment instrument can include a physical card, a virtual card, a checking account or other banking account, or any other identifier that links the user of the account 122 to the account 122.

In some examples, an account 122 can be associated with multiple payment instruments and/or multiple users. For example, if the account 122 is a business account for an artist 116, then multiple entities affiliated with the artist 116 can use respective payment instruments to access the balance of the account 122. The account 122 may display a request for user input that designates a user as an owner of the account 122. A user designated as an owner of the account 122 may have access to one or more functionalities not accessible by other users of the account 122. Example functionalities accessible by a user designated as an owner of an account 122 include, but are not limited to, a capability to update or modify one or more account settings and a capability to approve or deny one or more data transactions for withdrawing from a balance of the account 122, among others.

In some examples, the payment service system 120 can manage the balances of an account 122 by incrementing a balance when a data transaction indicating a payment is received and by decrementing or withdrawing from the balance when a data transaction (e.g., indicating a purchase, a peer-to-peer payment, repayment of an advance or for credit, etc.) is received. In cases where the data transaction indicates purchase, the data transaction can be received from another computing device 108 (e.g., a computing device 108 of a merchant and/or a server system of an online marketplace). In variations, the data transaction indicating the payment can include information indicating a type of purchase (e.g., a merchant category and a category of goods or services purchased), a value of the purchase (e.g., how much a purchased good or service cost), among other data. In some examples, the data transaction indicating the payment can be received from the media content service provider systems 102. For example, an account 122 of an artist 116 and/or other entities related to a media content item 118 and/or an artist 116 can be credited for royalties or resource allocation earned from engagement by the users 104 with media content items 118 produced by the artist 116. The data transaction can include information indicating a real or actual resource allocation for the artist 116 over a historical time period (a past day, a past week, a past month, etc.).

The media content service provider systems 102 can implement an engagement platform 126 that includes a monitoring system 128. A monitoring system 128 of an engagement platform 126 can collect engagement data 130 that indicates interaction or engagement of one or more users 104 with media content items 118 in the media content service provider systems 102. Example engagement data 130 includes, but is not limited to, a numerical quantity or number of times respective media content items 118 are engaged with, a duration of engagement by a user 104 with the media content items 118, a geographic location of a user 104 when engaging with the media content items 118, and an account type of a user account 114 of a user 104 engaging with the media content items 118, among other engagement information. Engagement with a media content item 118 can include, but is not limited to, a user 104 listening to a media content item 118, viewing a media content item, or otherwise streaming a media content item 118.

In some examples, the monitoring system 128 stores the engagement data 130 and the media content items 118 at storage 132 of the media content service provider systems 102. The storage 132 may be configured in various ways to store data. For instance, the storage 132 can include or otherwise have access to one or more databases, virtual storage, and so forth. Alternatively, or in addition, the storage 132 includes one or more data tables, data stores, and so on, that may be physically or logically separated (e.g., physically remote from one another and/or partitioned to store different data). In some examples, the storage 132 includes hundreds, thousands, hundreds of thousands, or millions (and so on) of media content items 118 and corresponding metadata of the media content items 118 (artist, release date, album, genre, beats per minute, etc.), as well as the engagement data 130 for the media content items 118.

Conventional techniques for compensating an artist 116 for engagement with the media content items 118 of the artist 116 can include periodically crediting or providing an account 122 of the artist 116 and/or the other entities with a real resource allocation for the period (e.g., by incrementing a balance of the account by the real resource allocation). The real resource allocation may additionally, or alternatively, be referred to as a royalty payment. For example, an artist 116 can earn a resource allocation when the media content items 118 are streamed, downloaded, and/or used in media. The media content service provider systems 102 analyze the engagement data for a historical time period (how long the media content items 118 were streamed for, whether a user account 114 of the user 104 streaming the media content items 118 has a paid subscription or is an unpaid user account 114, a geographic location of the user 104 streaming the media content items 118, etc.) to determine the resource allocation for the historical time period. The historical time period can include one or more days, one or more weeks, one or more months, etc., such that the account 122 is credited once per historical time period. The credit to the account 122 may be further delayed, such that the account 122 is credited several periods after the latest historical time period (e.g., one or more days, weeks, or months delayed). Thus, in conventional systems a balance of an account 122 of an artist 116 and/or other entity are not updated in real-time and are outdated by at least the historical time period.

Additionally, or alternatively, there may be numerous entities that are entitled to royalties from streaming of the media content items 118 (e.g., producers, distributors, songwriters, and record labels, among other entities). Conventionally, different digital service providers, such as the media content service provider systems 102, can provide resource allocation for streaming of the media content items 118 at different timing intervals. The resource allocation can initially be routed to a distributor that the media content service provider systems 102 receive the media content items 118 from. The distributors then pay record labels (e.g., a company that specializes in the production, distribution, and promotion of media content items 118) or artists 116 directly if the artists 116 are not represented by a record label. If the artists 116 are represented by a record label, then the record label can cause another delay in resource allocation to the artist 116. There may be other rightsholders who are entitled to royalties as well, which can affect the payouts, such as songwriters, producers, other band members, and so forth. Accordingly, in conventional systems, artists 116 may not have access to a resource allocation for streaming of respective media content items 118 in real-time and may not have access to the resource allocation for an extended period of time (e.g., anywhere from three months to a year or more).

In conventional examples, the payment service system 120 receives the real resource allocation to credit the account 122 (e.g., a payment) from one or more third-party services, such as a distributor service and/or a label service for the artist 116. Thus, information related to crediting the account 122 may be exchanged across multiple services and/or platforms, resulting in increased signaling overhead and increased usage of computational resources to process the information (e.g., memory and/or processing resource). For example, the media content service provider systems 102 transmit the engagement data 130 for a historical time period to a third-party service, and the third-party services determines the real resource allocation for an artist 116 over the historical time period using the engagement data 130. The third-party service transmits the real resource allocation to the payment service system 120 to credit the account 122 of the artist 116. The media content service provider systems 102, the payment service system 120, and the third-party service being implemented independent of one another (at different applications, platforms, servers, systems, etc.) results in increased signaling overhead due to the exchange of data between the different systems and services.

In conventional systems, the delay caused by periodically crediting a balance of an account 122 using engagement data over a historical time period, as well as the media content service provider systems 102, the payment service system 120, and the third-party service being implemented independent of one another, can result in one or more inefficiencies. For example, because the balance of the account 122 is not credited in real-time, a computing device 108 may receive user input from an artist 116 that indicates a request for additional information regarding the balance. The request for additional information may include a request for timing information regarding a schedule for crediting the account 122 with a real resource allocation. The computing device 108 may transmit signaling to the payment service system 120 and/or to the media content service provider systems 102 to obtain a response to the request for additional information, which causes additional signaling overhead. The increase in signaling may additionally, or alternatively, cause an increased usage of computational resources at the computing device 108 (processor, power, memory, etc.) due to displaying the additional information and processing the request. Further, the artist 116 may attempt to withdraw a balance from the account 122 that has not yet been credited to the account 122, which may be referred to as over drafting the account 122. Over drafting the account 122 may result in increased signaling overhead and increased usage of computational resources due to one or more messages to notify the artist 116, a merchant, and/or other parties affiliated with the payment service system 120 about the attempt to withdraw the balance.

In some examples, to reduce the inefficient use of computational resources, as well as to reduce signaling overhead, a payment service system 120 and/or one or more media content service provider systems 102 can predict or estimate a future resource allocation for respective media content items 118 of an artist 116, and then can credit or provide an account 122 of the artist 116 and/or of another entity related to the artist 116 with the estimated resource allocation in real-time (e.g., as the media content items 118 of the artist 116 are engaged with or interacted with by a user 104). For example, a resource allocation estimation system 134, which may be implemented at the media content service provider systems 102 and/or the payment service system 120, can estimate a streaming count for one or more media content items 118 for a future time period and can forecast a resource allocation or pay of an artist 116 for the estimated streaming count over the time period. The payment service system 120 can facilitate an advance of funds that includes at least a portion of the estimated resource allocation to the account 122 of the artist 116 during the time period.

In variations, the resource allocation estimation system 134 can generate historical streaming data 136 using the engagement data 130 for the media content service provider systems 102. The historical streaming data 136 includes historical streaming counts for respective media content items 118 in a media content library of a media content service provider system 102 over a historical time period (a previous day, a previous week, a previous month, a previous year or set of years, etc.). The resource allocation estimation system 134 can identify a list or set of media content items 118 from the media content library for an artist 116 using an identifier of an artist 116 and metadata indicating media content items 118 available for streaming or engagement by users 104 on the media content service provider system 102. The resource allocation estimation system 134 can obtain permission from a user of the account 122 (e.g., an artist 116) to access historical streaming data 136 for the set of media content items 118. The resource allocation estimation system can use one or more machine learning models and/or other time-series forecasting techniques to obtain an estimated streaming count total for a future time period.

For example, the machine learning engine 138 can implement one or more machine learning models and/or AI models to output an estimated streaming count based on the historical streaming data 136. For a time interval, t, the real or actual streaming count for a media content item 118 can be denoted as S_{1,t}, and a historical streaming data set for the media content item 118 can be denoted as S_{1,t-1}. The actual streaming count for the media content item 118 is a numerical quantity of streams over a time period for which the streaming count is estimated. Additionally, or alternatively, there may be one or more additional data sets, S_{2,t-1}, S_{3,t-1}, etc. for corresponding second, third, etc., media content item 118. The additional data sets can be a portion or an entirety of a corpus of data including streaming counts for different media content items 118 from one or more artists 116, such as a variety of different artists 116. Additionally, or alternatively, the additional data sets can include, but are not limited to, calendar data (e.g., indicating holidays or other calendar events that may impact streaming counts for one or more media content items 118), information about an artist 116 (a birthday of an artist 116, a death of an artist 116, etc.), and current events or other relevant news events, among other information. The additional data sets can indicate a condition related to at least one media content item. Example conditions related to the media content item can include, but are not limited to, current events or other news events related to the media content item 118, such as whether a title of the media content item 118 matches a value in a publication released within a threshold time period from a current date, whether a name of the artist 116 of the media content item 118 matches a value in a publication released within a threshold time period from a current date, or whether any other information related to the media content item 118 matches a value in a publication released within a threshold time period from a current date. A publication can include articles, papers, books, reports, video (e.g., television, movies, videos accessible via streaming services, etc.), among other information accessible by the public. Additionally, or alternatively, example conditions can include social media trends that incorporate and/or reference the artist 116 and/or the media content item 118. Additionally, or alternatively, the additional data sets can include information related to the media content item 118, such as a genre of the media content item 118 and/or one or more audio or video features of the media content items 118.

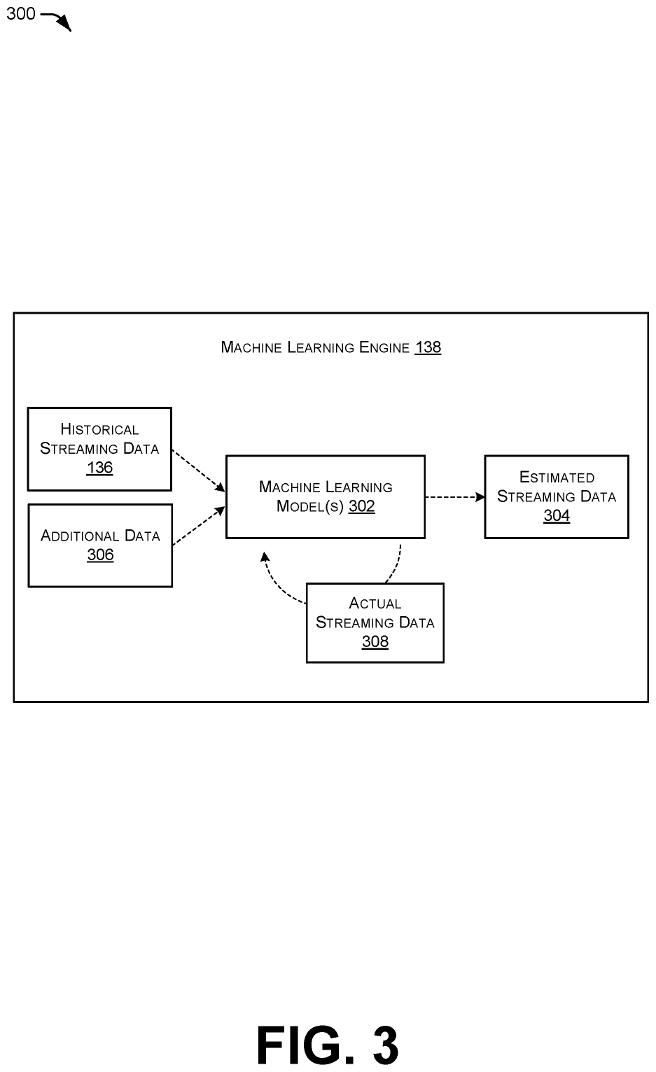

The machine learning engine 138 can input the historical streaming data 136 to one or more machine learning models trained to output an estimated streaming count for respective media content items 118 over a time period, which is described in further detail with respect to FIG. 3. The machine learning engine 138 can analyze the historical streaming data 136 to identify one or more patterns or trends in the historical streaming data 136 using the machine learning models and/or time-series forecasting techniques. Time-series forecasting techniques can involve analyzing historical data to identify information including patterns, trends, and seasonality, and then using this information to build mathematical models that can forecast future values. Common techniques used in time-series forecasting include moving averages, exponential smoothing, autoregressive integrated moving average (ARIMA) models, and more advanced machine learning algorithms, like neural networks and support vector machines. Thus, the machine learning engine 138 can obtain an estimated streaming count for a media content item 118 for a time period t, denoted as S*_{1,t}.

In variations, the resource allocation estimation system 134 can determine volatility information of the streaming count for a media content item 118 based on differences between streaming counts for different time periods and can use the volatility information to determine the estimated streaming count. For example, a media content item 118 with a greater volatility can have a relatively low estimated streaming count, while a media content item 118 with a lower volatility can have a relatively high estimated streaming count. A media content item 118 on one or more playlists of a media content service provider system 102 can have a greater volatility than media content items 118 that are not on one or more playlists on the media content service provider system 102.

Once the resource allocation estimation system 134 obtains the estimated streaming count for the media content item 118 for the time period (e.g., S*_{1,t}), the resource allocation estimation system 134 can forecast earnings or an estimated resource allocation for the time period, denoted as D*_{1,t}. The resource allocation estimation system 134 can send the estimated streaming count to the payment service system 120 for respective media content items 118 in a media content library of a media content service provider system 102. The payment service system 120 can use historical payment data for the media content items 118 and the estimated streaming count to obtain initial estimated resource allocations for the media content items 118. Additionally, or alternatively, the media content service provider system 102 can obtain the historical streaming data from the payment service system 120, and the media content service provider system 102 can use the historical payment data and the estimated streaming count to obtain the initial resource allocations for the media content items 118. The payment service system 120 and/or the media content service provider systems 102 can obtain the historical streaming data via a distributor service. The distributor service can additionally, or alternatively, provide information for respective percentages or a split of resource allocation for a media content item 118 between different entities (the artist 116, producer, distributor, songwriter, record label, band members, etc.). The historical payment data can include a series of data sets for respective media content items 118 and can be denoted as D_{1,t-k}, D_{1,t-k-1}, etc. for a media content item 118 (e.g., a first media content item 118), where k is a numerical quantity of time periods since payment information was last available. The lag or delay between a current time period and when the payment information was last available can be referred to as a payment lag or a reporting lag.

The media content service provider systems 102 and/or the payment service system 120 can compute a historical pay rate from the historical payment data for respective media content items 118. For example, the media content service provider systems 102 and/or the payment service system 120 can determine a resource allocation for an artist 116 or other entity per engagement with a media content item 118 by determining a historical resource allocation for one or more defined historical time periods and a numerical quantity of engagements with the media content item 118 during the historical time periods. The historical pay rate for a media content item 118 can be represented by dollars per stream or engagement with a media content item 118. Once the media content service provider systems 102 and/or the payment service system 120 estimate a streaming count for a media content item 118 over a future time period and a historical pay rate for the media content item 118, then the media content service provider systems 102 and/or the payment service system 120 can calculate an initial estimated resource allocation over the future time period (e.g., as a product of the historical pay rate and the streaming count).

In variations, the media content service provider systems 102 and/or the payment service system 120 can analyze the engagement data 130 to determine one or more streaming patterns or engagement patterns over a time period (e.g., throughout a day). For example, the media content service provider systems 102 and/or the payment service system 120 can detect a pattern of one or more increases and/or decreases in engagement with a media content item 118 throughout the time period, such as an increase in engagement with one or more media content items 118 during one or more commute times for the users 104 and a decrease in engagement with one or more media content items 118 during a time period when users 104 are sleeping, among other examples. The media content service provider systems 102 and/or the payment service system 120 can compute an initial estimated resource allocation according to the determined patterns over the time period, such that the initial resource allocation varies over the time period as engagement varies over the time period. In some examples, the time period can be any length of time, such that the media content service provider systems 102 and/or the payment service system 120 obtain an initial estimated resource allocation for an artist 116 and/or the other entity for any duration for which the artist 116 and/or the other entity is owed royalties or an advance in resource allocation (e.g., future royalties for streams or engagement that is currently occurring, occurred in a previous time period but has yet to be compensated, and/or is predicted for a future time period).

As the initial estimated resource allocations are predictions of future events, the initial estimated resource allocations for respective media content items 118 can deviate from actual resource allocations for various reasons. The deviations can include, but are not limited to, variations in an estimated streaming count for the media content items 118 and variations in an estimated pay rate for the media content items 118. For variations in an estimated streaming count for the media content item 118, the media content service provider systems 102 and/or the payment service system 120 can obtain an actual streaming count, Sₜ, for respective media content items 118 (e.g., after the end of a time period, denoted as t+1). The media content service provider systems 102 and/or the payment service system 120 can incorporate the actual streaming count into the historical streaming data 136. The machine learning engine 138 can continue to train the machine learning models using the updated historical streaming data 136 to further refine or improve an accuracy of the machine learning models, as described in further detail with respect to FIG. 3. For example, continuing to train the machine learning models using the historical streaming data 136 can improve an ability of the machine learning models to predict an accurate streaming count for the media content item 118.

For variations in an estimated pay rate for the media content items 118, the media content service provider systems 102 and/or the payment service system 120 can obtain a real pay rate for the media content items 118 (e.g., after the end of a time period), such as once a balance of the account 122 is credited by a third-party payment service, which is described in further detail with respect to FIG. 2. The media content service provider systems 102 and/or the payment service system 120 can incorporate real pay rate data including one or more real pay rates into the historical pay rates and can use time-series forecasting techniques to continue to obtain the estimated pay rates from the updated historical pay rates. Continuously updating the historical pay rates and using the historical pay rates to obtain an estimated pay rate can improve accuracy of the estimated pay rate for the media content items 118.

Additionally, or alternatively, to account for one or more variations in the initial estimated resource allocations for the media content item 118, the media content service provider systems 102 and/or the payment service system 120 can calculate a confidence interval for the initial estimated resource allocation for respective media content items 118 and/or for an artist 116 or other entity. The media content service provider systems 102 and/or the payment service system 120 can measure a variability of a time-series history of resource allocations for media content items 118 (e.g., a standard deviation of a recent, possibly recency-weighted, window of past values). The media content service provider systems 102 and/or payment service system 120 can select a confidence level from the confidence interval to apply to the initial estimated resource allocation. That is, the media content service provider systems 102 and/or the payment service system 120 can use the confidence level to determine an estimated resource allocation from the initial resource allocation that accounts for a confidence level that the initial estimated resource allocation is accurate. For example, the media content service provider systems 102 and/or the payment service system 120 can select a lower bound of an 80% confidence interval, in which case instead of overestimate 50% of the time, the media content service provider systems 102 and/or the payment service system 120 may overestimate 10% of the time (e.g., 100%−80%/2), thus making the system more conservative (e.g., to reduce risk).

In some examples, a size (e.g., width) of the confidence interval depends on one or more factors, including the amount of data (e.g., less data can result in a wider confidence interval), the variability of the data (e.g., high variance can result in a wider confidence interval), and a confidence level selection. In variations, the media content service provider systems 102 and/or the payment service system 120 select a 95% confidence level as a default confidence level, or an 80% or lower confidence level for a narrower interval converging toward a precise estimated resource allocation, which represents a risk-neutral estimate. Additionally, or alternatively, the media content service provider systems 102 and/or the payment service system 120 can select a confidence level at an upper bound of an interval, taking on additional risk. For example, the media content service provider systems 102 and/or the payment service system 120 can implement a loss-leader strategy to incentivize one or more artist 116 to implement the procedure to advance resource allocation.

In variations, the confidence interval can be adjusted (e.g., widened or narrowed) according to one or more factors, including, but not limited to, for different artists 116, different genres of media content items 118, different geographic locations where the users 104 engage with the media content items 118, different durations over which the artist 116 has been producing media content items 118, different record labels, and different distributors. For example, the payment service system 120 can collect information related to one or more withdrawal patterns from the balance of the account 122 and can use the information to determine whether to widen or narrow the confidence interval. If the artist 116 frequently withdraws a relatively large portion of the balance (e.g., greater than a threshold numerical quantity of withdrawals that satisfy a threshold value or a threshold percentage of a balance of the account 122), then the payment service system 120 and/or the media content service provider systems 102 can narrow the confidence interval. If the artist 116 does not frequently withdraw a relatively large portion of the balance (e.g., less than a threshold numerical quantity of withdrawals that satisfy a threshold value or a threshold percentage of a balance of the account 122), then the payment service system 120 and/or the media content service provider systems 102 can widen the confidence interval.

Additionally, or alternatively, the payment service system 120 can receive information related to a data transaction for a purchase, such as indicating one or more categories of the purchase (e.g., a category of a merchant, a category of a good, or a category of a service), as well as a value of the purchase. The payment service system 120 can evaluate the information to determine whether the purchase is relevant to the media content items 118, a business of the artist 116, or the like. If a threshold value withdrawn from the balance of the account 122 is related to purchases that advance a business of the artist 116 and/or creation of additional media content items 118 (payment for use of a recording studio, payment for a new musical instrument, payment for recording tools, etc.), then the payment service system 120 and/or the media content service provider systems 102 can widen the confidence interval. If a threshold value withdrawn from the balance of the account 122 is not related to purchases that advance a business of the artist 116 and/or creation of additional media content items 118, then the payment service system 120 and/or the media content service provider systems 102 can narrow the confidence interval. Thus, the confidence interval can be adjusted (e.g., widened or narrowed) for different artists 116 based on spending habits of the artist 116.

The payment service system 120 and/or the media content service provider systems 102 can determine a size of the confidence interval for a single artist 116 based on data related to multiple artists 116. The data can include a genre of the artists 116, streaming counts for the artists, fan behaviors for the artists, and the like. Using the data related to the multiple artists 116 to determine the size of the confidence interval can reduce the risk of providing an estimated resource allocation to the artist 116 by using the data to increase an accuracy of the estimated resource allocation according to the confidence interval.

The media content service provider systems 102 and/or the payment service system 120 can select the confidence level from the confidence interval as a response to detecting one or more variations in the initial estimated resource allocations and/or estimated streaming counts for media content items 118 (e.g., media content items 118 produced by an artist 116). The media content service provider systems 102 and/or the payment service system 120 can perform one or more comparisons to select the confidence level. For example, the media content service provider systems 102 and/or the payment service system 120 can compare actual streaming counts for previous time periods to actual estimated streaming counts for the previous time periods. If the comparison results in the actual streaming count for a previous time period being the same as an estimated streaming count for that previous time period, then the media content service provider systems 102 and/or the payment service system 120 can maintain (e.g., not update) a confidence interval and/or select a same confidence level. If the comparison results in an actual streaming count for a previous time period being greater than an estimated streaming count for that previous time period, then the media content service provider systems 102 and/or the payment service system 120 can subsequently proportionally decrease the confidence level. If the comparison results in an actual streaming count for a previous time period being less than an estimated streaming count for that previous time period, then the media content service provider systems 102 and/or the payment service system 120 can subsequently proportionally increase the confidence level. A higher confidence level results in wider bounds for a confidence interval, while a lower confidence level results in narrower bounds for a confidence interval.

In some examples, if the payment service system 120 determines that an initial estimated resource allocation or estimated streaming count is greater than a real resource allocation or an actual streaming count, which leads to overpayment, due to variations in an estimated pay rate for the media content items 118 (e.g., a prior advance was not fully recouped on time because a real pay rate for a media content item 118 was lower than estimated), then the media content service provider systems 102 and/or payment service system 120 can subsequently proportionally increase the confidence level for one or more of a streaming count or a pay rate estimation for the media content items 118. The media content service provider systems 102 and/or the payment service system 120 can use an updated estimated resource allocation that is a lower bound of the confidence interval for advanced payments to reduce variations related to overestimating an estimated resource allocation for a media content item 118, and also reducing a risk related to overestimating the resource allocation and delays related to recouping advanced resource allocations that are overestimated.

Similarly, the media content service provider systems 102 and/or the payment service system 120 can determine an initial estimated resource allocation is less than a real resource allocation, which leads to underpayment, due to variations in an estimated pay rate for the media content items 118 (e.g., a prior advance was recouped early or in excess, so the media content service provider systems 102 and/or the payment service system 120 could have advanced the artist 116 or other entity a greater resource allocation). The media content service provider systems 102 and/or the payment service system 120 can subsequently proportionally decrease a confidence level for one or more of a streaming count or a pay rate estimation to determine an updated estimated resource allocation by increasing the initial estimated resource allocation.

The payment service system 120 can credit or provide a balance of an account 122 of an artist 116 with estimated resource allocations (e.g., the updated estimated resource allocations based on the selected confidence level) over a time period in advance of receiving data transactions from one or more third parties. In variations, the third parties can include, but are not limited to, a distributor service, a financial institution, and/or a label service, among others. The data transactions can include a real resource allocation for the time period, and the payment service system 120 can calculate a difference between the real resource allocation and the estimated resource allocation credited to a balance of the account 122. For example, the payment service system 120 can track real resource allocations credited to a balance of an account 122 in real-time. The payment service system 120 can cross reference the real resource allocations to the estimated resource allocations using transaction metadata to identify data transactions in which the estimated resource allocations are credited to the balance of the account 122. The payment service system 120 can flag the estimated resource allocations for comparing the estimated resource allocations to a real resource allocation for determining the difference. In some examples, the payment service system 120 can adjust the balance of the account 122 after the time period to account for the difference (e.g., by increasing the balance by the difference if the real resource allocation is greater than the estimated value or by decreasing the balance by the difference if the real resource allocation is less than the estimated value). Thus, a payment service system 120 can credit a balance of an account 122 in real-time by forecasting a resource allocation over a future time period and making the resource allocation available to the artist 116.

Additionally, or alternatively, to reduce the inefficient use of computational resources, as well as to reduce signaling overhead, related to the media content service provider systems 102, the payment service system 120, and the third-party service being implemented independent of one another, an application 106 for the payment service system 120 can be linked to and/or implemented by an application 106 for one or more media content service provider systems 102. For example, the application 106 integrates the payment service system 120 and the media content service provider systems 102 to facilitate payment services for engagement with one or more media content items 118. The artist 116 may provide a single set of user credentials (e.g., username and password) to the application 106 to access both the payment service system 120 and the media content service provider systems 102, which may be referred to as a single sign-on (SSO). For example, an artist 116 provides user credentials to a payment service application that implements the payment service system 120 and can SSO into an application 106 for receiving one or more estimated resource allocations in advance of a real resource allocation. The application 106 can initiate a call to an API of the payment service application to obtain access to information from the payment service application, to provide a resource allocation to a balance of an account 122 of the artist 116, or to withdraw a value from the balance of the account 122 of the artist 116.

In some examples, the payment service system 120 and/or the media content service provider systems 102 can identify one or more artists 116 of a population of artists 116 that are to be provided with an estimated resource allocation in advance of a real resource allocation. For example, the payment service system 120 analyzes transaction data to filter for resource allocation or payments received from organizations that perform royalty-based resource allocation or for payments that satisfy one or more criteria indicative of the royalty-based resource allocation. The criteria can include, but is not limited to, one or more variations in resource allocations for respective time periods (e.g., pay periods), a frequency of reception of resource allocations, or a magnitude of the resource allocations, among others.

In some examples, the payment service system 120 can perform string matching to detect organizations that perform royalty-based resource allocation. For example, the payment service system 120 can parse one or more string values in a record for one or more accounts (e.g., an account ledger for respective accounts of the payment service system 120), where the values are related to a deposit of a resource to a respective account. Example values include, but are not limited to, a name or title of an organization that is depositing the resource to the respective account, a value indicating a category of the deposit of the resource to the respective account, and a value defining a purpose for depositing the resource to the respective account, among other values. The payment service system 120 can compare the parsed values to a list of known values related to royalty-based resource allocation (e.g., categories for royalty-based resource allocations, names of organizations that perform royalty-based resource allocations, etc.). The payment service system 120 and/or the media content service provider systems 102 may display a message and/or a selectable control via an instance of the application 106 to notify an artist 116 of an option to receive the advanced resource allocations. In some examples, the message can indicate an estimated resource allocation for a future time period (a following day, the next hour, the next minute, etc.). The instance of the application 106 can receive user input from the artist 116 via the selectable control that requests additional information regarding the advanced resource allocation, to accept the advanced resource allocation option, and/or to reject the advanced resource allocation option.

Additionally, or alternatively, an instance of an application 106 can receive user input from an artist 116 (e.g., a name of an artist 116) that initiates a search via a search feature of the instance of the application for respective resource allocations for one or more media content items 118 of an artist 116, which is described in further detail with respect to FIG. 7. The media content service provider systems 102 propagate one or more search results by obtaining one or more media content items 118 of the artist 116 from a library of media content items 118 (e.g., catalog data). In variations, the search results can include media content items 118 supported by a distributor service affiliated with the media content service provider systems 102, such that the estimated resource allocations have an increased accuracy. In some examples, the media content service provider systems 102 and/or the payment service system 120 can use information to obtain resource allocation for the artist 116, resource allocation for one or more different entities related to the artist 116, and pay rates provided by a distributor service, and the media content service provider systems 102 and/or the payment service system 120 can use the information to determine the estimated resource allocations (e.g., once an artist 116 accepts the advanced resource allocation option).

In some examples, the payment service system 120 can implement a loan service or a payment advance service to credit or provide a balance of an account 122 with an estimated resource allocation before obtaining a real resource allocation. The loan service or the payment advance service can include a loan or advance payment with a type defined for the estimated resource allocation (e.g., a limited recourse loan type or a limited recourse advance type). Thus, the payment service system 120 can record a loan or payment advance when a balance of an account 122 is credited or provided with an estimated resource allocation.

In some examples, the payment service system 120 can determine a type of a user based on information obtained from an account 122 (e.g., a username of the account, account metadata, user data, relevant balance information for the account 122, relevant transaction information for the account 122, a history of lending for the account 122, credit reporting information, etc. from the application 106 or a financial institution). Example types of users include, but are not limited to, artists 116, producers, distributors, songwriters, a record label, or the like. As users link accounts for publishing media content items 118 to the application 106, the media content service provider systems 102 and/or the payment service system 120 can evaluate the opportunity to perform advanced resource allocation to respective entities (e.g., an artist 116, a producer, a distributor, a songwriter, a record label, or the like). In some examples, a payment service system 120 can utilize an account 122 and user input provided via the application 106 to enable advanced resource allocation for the respective entities (e.g., providing funds to the account 122 prior to consideration being received in return from the artist 116). For example, the computing device 108 can prompt a user of the account 122 via the application 106 to enable the advanced resource allocation for the user. In variations, the payment service system 120 can determine a resource allocation to advance to a balance of an account 122 using an expected or estimated streaming count and corresponding estimated earnings for the streaming count for a future time period (e.g., estimated earnings for a day). The payment service system 120 can determine an additional value to add to the estimated earnings (e.g., based on a confidence level for the user of the account 122), where the resource allocation includes the estimated earnings and the additional value.

In some examples, the payment service system 120 can credit or provide the resource allocation to a balance of an account 122. The payment service system 120 can recoup the resource allocation from a credit to the balance of the account 122 by a third-party payment service, which is described in further detail with respect to FIG. 2. For example, the payment service system 120 can withdraw the resource allocation according to a periodicity of payments by the third-party payment service (daily, weekly, monthly, etc.). A user of the account 122 (e.g., the artist 116) may provide user input approving the payment service system 120 to access underwriting data sources, including third-party payment service credentials (e.g., royalty payor credentials), data about media content items 118 of an artist 116 from the media content service provider systems 102, and information about engagement with the media content items 118 on respective media content service provider systems. Additionally, or alternatively, the user of the account 122 may provide user input approving the payment service system 120 to trigger one or more actions, such as initiating withdrawals from the balance of the account 122 to recoup and/or repay for the advance of the resource allocation.

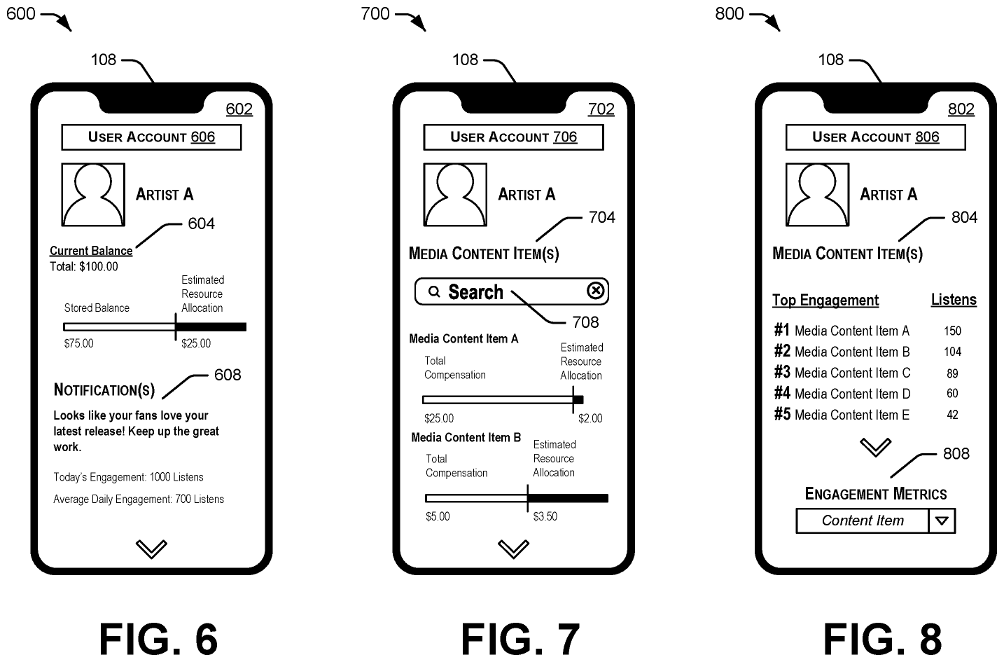

In one or more scenarios, the computing device 108 presents a user interface to a user 104 and/or to the artist 116, the user interface displaying one or more features of the application 106. By way of example and not limitation, the features of the application 106 include one or more input/output (I/O) features (e.g., interactive elements) with which the user can interact with the application 106 via the user interface. For instance, the artist 116 can provide user input via the user interface (e.g., via one or more interactive elements of the user interface) to view a balance of an account 122, to enable or approve features of the payment service system 120 related to the advance of the resource allocation for user engagement with media content items 118, and/or to navigate one or more features of the application 106 (e.g., which is described in further detail with respect to FIGS. 6 through 8), among other interactions. For example, the media content service provider systems 102 and/or the payment service system 120 output information for display via a user interface of the application 106. The information can be related to resource allocation for engagement with one or more media content items 118, including one or more balances of an account 122, a searchable feature for displaying resource allocations for respective media content items 118, and/or a ranked list of resource allocations for respective media content items 118.

In some examples, the application 106 outputs a balance of the account 122 for display to the artist 116 via the user interface of the computing device 108 in real-time. Additionally, or alternatively, the application 106 outputs information related to repayment data transactions for the advanced resource allocation, such as a value of the repayment data transaction and/or a date and time of occurrence of the repayment data transaction, among other information. The media content service provider systems 102 and/or the payment service system 120 can maintain or control applications for receiving or opting into the advance resource allocation for engagement with media content items 118 from users of accounts 122 (e.g., including the artist 116), underwriting, and data analytics for the advance resource allocation for engagement with the media content items 118 through the application 106. A third-party service (e.g., a loan service or payment advance service) can support backend systems for providing or crediting a balance of an account 122 with resource allocations in advance.

In some cases, the payment service system 120 can suspend advanced resource allocation services if the payment service system 120 fails to acquire or obtain data related to estimating the resource allocation (e.g., loss of access to the data). Additionally, or alternatively, the payment service system 120 can suspend advanced resource allocation services if the payment service system 120 detects a change in a financial institution linked to the account 122, if one or more media content items 118 for the artists 116 are removed from the media content service provider systems 102, if there is an increase in engagement with the media content items 118 that satisfies (e.g., exceeds) a threshold value, or the like. In some examples, the media content service provider systems 102 and/or the payment service system 120 can monitor for triggering events that result in one or more increases in resource allocation, but that may not result in a long-term increase in engagement with the media content items 118. An example triggering event includes, but is not limited to, an artist signing with a record label. The media content service provider systems 102 and/or the payment service system 120 can provide positive feedback, such as by displaying a message via the user interface that indicates the positive feedback, for the increase in resource allocation without increasing an estimated resource allocation, as the increase in resource allocation may not result in increase in engagement with the media content items 118.

A description of compensating a user account 122 with an estimated resource allocation for a time period in the future is provided in further detail below.

FIG. 2 is a block diagram depicting a non-limiting example environment 200 showing resource allocation to an account of FIG. 1 in greater detail in accordance with one or more implementations.

In the example environment 200, a resource allocation estimation system 134 and one or more media content service provider systems 102 are depicted as interacting with an account 122, which may be examples of a resource allocation estimation system 134, one or more media content service provider systems 102, and an account 122 (e.g., of an artist 116), as described with reference to FIG. 1. For example, the example environment 200 illustrates a flow of resource allocation between the resource allocation estimation system 134, an account 122, a payment instrument 202, a financial institution 204, and/or a third-party payment service 206. In some examples, the media content service provider systems 102 can implement, or can be implemented by, a payment service system (e.g., a payment service system 120 as described with reference to FIG. 1) via a same application. Additionally, or alternatively, the media content service provider systems 102 can communicate with the payment service system, where the media content service provider systems 102 and the payment service system are implemented independently (e.g., at different applications) and can communicate directly, such as via an API. Aspects of the example environment 200 that are described as being performed by the media content service provider systems 102 may additionally, or alternatively, be performed by a payment service system.

In variations, the payment instrument 202 may be an example of a credit card, a debit card, a checking account, a savings account, a cash application account, a card provided by the cash application account, or any other type of payment instrument 202 linked to or provided by an application that implement a payment service system and/or one or more media content service provider systems, as described with reference to FIG. 1. A user of the account 122 (e.g., an artist and/or another entity) can use the payment instrument 202 at one or more merchant systems to credit resources to or withdraw resources from a balance 208 of the account 122. In some examples, a user of the account 122 can have multiple payment instruments 202 for different use cases (e.g., a personal payment instrument 202 and/or a business payment instrument 202). Additionally, or alternatively, the account 122 can have multiple users (an artist, a tour manager, an entity that picks up merchandise, etc.), and respective users can have different payment instruments 202. The account 122 can be provided with one or more incentives with partner services or partner marketplaces to promote career growth spending (e.g., a musical instrument marketplace, a recording studio, and a merchandise marketplace, among others).

The balance 208 of the account 122 represents resources (e.g., a monetary value) accessible by a user of the account 122 to pay for one or more goods, services, or other items for sale. The financial institution 204 can be an example of a bank, or other financial institution, which is linked to the account 122 for crediting or withdrawing a value to or from the balance 208. The third-party payment service 206 can be any service that provides resource allocation, such as by paying royalties and/or advances to the account 122. For example, the third-party payment service 206 can be a distributor service of one or more media content items, a record label service of one or more media content items, a producer service of one or more media content items, and/or a media content service of one or more media content items, among other services.

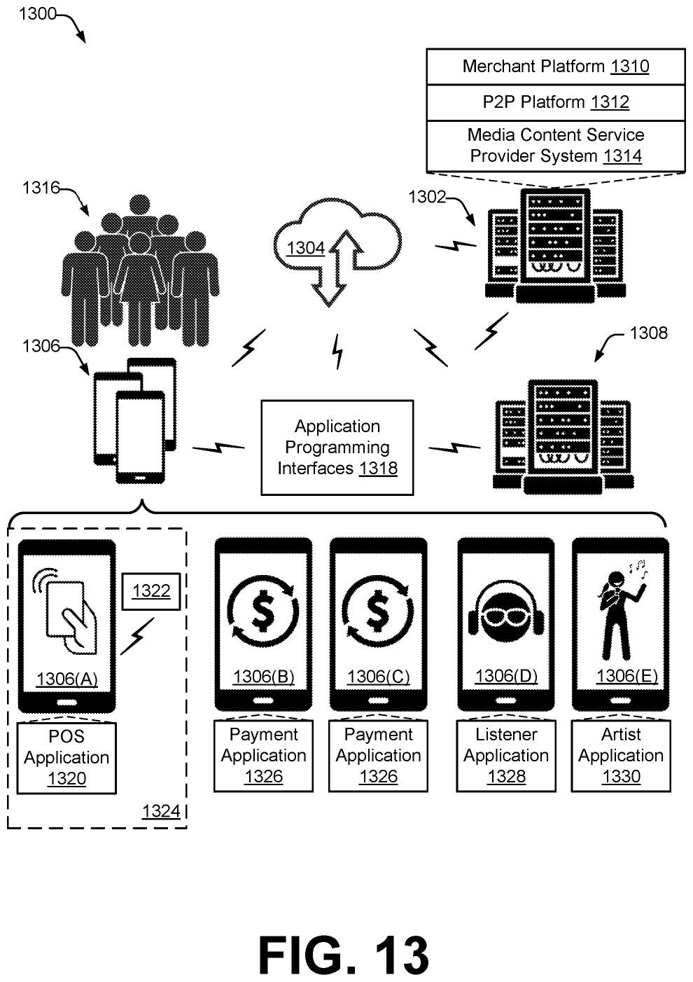

In some examples, artists may receive resource allocations in the form of cash on a peer-to-peer (P2P) payment platform, where the P2P payment platform is described in further detail with respect to FIG. 13. For example, the artist may perform at a party, at a corporate event, or at any other event, and may receive resource allocation in the form of the P2P payment. The financial institution 204 and the third-party payment service 206 may be unaware of the resource allocation received in the form of the P2P payment. However, the media content service provider systems 102 can detect an increase in the balance 208 of the account 122 and can determine that the balance increase is due to resource allocation related to a career-building activity (e.g., a musical performance). The media content service provider systems 102 can use this additional resource allocation information to calculate a confidence interval and can select the confidence level from the confidence interval, as described with reference to FIG. 1.

In some examples, the resource allocation estimation system 134 estimates a resource allocation for a future time period of engagement with one or more media content items, as described with reference to FIG. 1. For example, the resource allocation estimation system 134 monitors engagement data 130 that includes engagement by users with respective media content items on a media content service provider system. The resource allocation estimation system 134 generates historical streaming data for the media content items over one or more previous time periods (over the last one or more days, one or more weeks, one or more months, one or more years, etc.). The resource allocation estimation system 134 determines an estimated streaming count of the media content items over a time period (a future one or more minutes, one or more hours, one or more days, one or more weeks, one or more months, etc.) using the historical streaming data for the media content items. The resource allocation estimation system 134 determines an estimated resource allocation for the artist of the media content items. For example, the resource allocation estimation system 134 uses the historical streaming data, historical resource allocation data 210 (e.g., a historical pay rate), and the confidence level to determine an estimated resource allocation, as described with reference to FIG. 1.

The resource allocation estimation system 134 increments, credits, or provides the estimated resource allocation to the balance 208 of the account 122 in advance of receiving a payment from the third-party payment service 206. In some examples, the third-party payment service 206 periodically credits the balance 208 of the account 122 with a real resource allocation for engagement with media content items over the period (daily, weekly, monthly, etc.). The media content service provider systems 102 detect the payment is received at the account 122 from the third-party payment service 206. For example, the media content service provider systems 102 monitor data transactions by the third-party payment service 206 and/or the account 122 to detect the payment is received at the account 122. Additionally, or alternatively, the media content service provider systems 102 receive a message indicating the payment is received at the account 122. In variations, a payment service system can detect an incoming deposit to the balance 208 of the account 122 and notify the media content service provider systems 102 of the incoming deposit. The media content service provider systems 102 can initiate a request to approve a withdrawal from the balance 208 of the account 122 to recoup the estimated resource allocation advanced to the balance 208 of the account 122.

The media content service provider systems 102 access the balance 208 (e.g., with permission from a user of the account 122), to credit and/or withdraw a value from the balance 208 of the account 122. For example, the media content service provider systems 102 determine a difference between the estimated resource allocation and a real resource allocation. If the estimated resource allocation is greater than the real resource allocation, then the media content service provider systems 102 withdraw the real resource allocation and also withdraw the difference from the balance 208 to recoup the estimated resource allocation. In some other examples, if the estimated resource allocation is greater than the real resource allocation, then the media content service provider systems 102 can refrain from crediting the account 122 with at least a portion of a future resource allocation for engagement with one or more media content items. For example, the media content service provider system 102 can subtract the difference from the future resource allocation prior to crediting the future resource allocation to the account to recoup the difference between the estimated resource allocation and the real resource allocation. Additionally, or alternatively, if the estimated resource allocation is greater than the real resource allocation, then the media content service provider systems 102 can output the difference between the estimated resource allocation and the real resource allocation for display to the user of the account 122 via a user interface of a computing device. The user of the account 122 can provide user input via the user interface to execute a data transaction that credits the media content service provider account 212 (e.g., make a payment to the media content service provider account 212) with a value equal to the difference between the estimated resource allocation and the real resource allocation, such that the difference is recouped.

If the estimated resource allocation is less than the real resource allocation, then the media content service provider systems 102 withdraw the estimated resource allocation from the balance 208 to recoup the estimated resource allocation, where the difference remains in the balance 208. The media content service provider systems 102 credit the withdrawn amount from the balance 208 to a media content service provider account 212. A payment service system 120 can manage the account 122 and/or the media content service provider account 212, as described with reference to FIG. 1.

Providing an artist with revenue for engagement with media content items in real-time by advancing resource allocation to the balance 208 of the account 122 provides for the artist to understand the flow of revenue, access a current value of a business, make investment decisions, and retain an option to stay independent. In variations, the media content service provider systems 102 can display one or more messages to users of the account 122 to indicate to the users to perform one or more actions based on information collected from the account 122. For example, the messages can indicate to the users to perform a collaboration with another artist, to indicate ownership of a songwriter profile, and/or to implement a directory of engagement, as appropriate, based on the information indicating one or more activities or purchases.

FIG. 3 is a block diagram depicting a non-limiting example environment showing the machine learning engine of FIG. 1 in greater detail as generating estimated streaming data in accordance with one or more implementations.

In one or more implementations, the machine learning engine 138 may be an example of the machine learning engine 138 as described with reference to FIG. 1. For example, the machine learning engine 138 can implement one or more machine learning models 302 and/or AI models to output estimated streaming data 304 including one or more estimated streaming counts for respective media content items on a media content service provider system based on the historical streaming data 136 and/or additional data 306. The machine learning engine 138 is configured to access data for training one or more machine learning models 302, where the data includes engagement data for respective media content items on the media content service provider system (e.g., the engagement data 130, as described with reference to FIG. 1), among other data. The other data can include, but is not limited to, a portion or an entirety of a corpus of data including streaming counts for different media content items from one or more artists, such as a variety of different artists. Additionally, or alternatively, the other data can include, but is not limited to, calendar data (e.g., indicating holidays or other calendar events that may impact streaming counts for one or more media content items), information about an artist (a birthday of an artist, a death of an artist, etc.), and current events or other relevant news events, among other information. Additionally, or alternatively, the other data can include information related to the respective media content items, such as a genre of the media content items and one or more audio or video features of the media content items.

In some examples, the machine learning engine 138 accesses a database to obtain stored data for training the machine learning models 302. The database may be an example of a storage 132, as described with reference to FIG. 1. The machine learning engine 138 generates the one or more machine learning models 302 by training or fine-tuning the one or more machine learning models 302 using the data. The machine learning models 302 can include a computational algorithm or system that learns patterns and relationships from data and makes predictions or decisions based on that learned knowledge. In the example environment 300, the prediction can include the estimated streaming data 304. Example machine learning models 302 include, but are not limited to, linear regression models, logistic regression models, decision trees, support vector machines, and neural networks, among others.

By utilizing the engagement data and other data related to an artist and/or one or more media content items to train the machine learning models 302, the machine learning models 302 can estimate a streaming count over a time period for a media content item using historical streaming data 136 and/or additional data 306 related to streaming and/or engagement with a media content item. The additional data 306 can include data related to the artist or the media content item from the media content service provider system (charting data, playlisting data, fan engagement data, etc.), data from a social platform related to the artist and/or the media content item, additional resource allocation data for the artist, among other data, where the social platform can include a social media application. Additionally, or alternatively, the additional data 306 can include a category of a purchase for an account, a frequency of purchases for the account, or how often a purchase withdraws from a virtual balance of the account (e.g., where the stored balance is withdrawn prior to the virtual balance), among other data.

In some examples, the machine learning engine 138 obtains actual streaming data 308 that indicates an actual streaming count of a media content item over the time period and/or a resource allocation for the actual streaming count of the media content item. The machine learning engine 138 uses the actual streaming data 308 to further train the machine learning models 302. For example, the machine learning engine 138 updates one or more parameters of the machine learning models 302 by inputting additional training data including the actual streaming data 308 to the machine learning models 302. The parameters can include, but are not limited to, coefficients and/or intercepts for a linear regression model or logistic regression model, splitting rules for nodes and/or thresholds for features of a decision tree model, support vectors and/or weights assigned to support vectors of a support vector machine, and weights and biases of nodes in a neural network, among other parameters. By continuing to update the parameters of the machine learning models 302, the machine learning engine 138 can increase an accuracy of the output from the machine learning models 302.

In some examples, the machine learning engine 138 determines, receives, or otherwise obtains the historical streaming data 136 and/or the additional data 306. The machine learning engine 138 can input the historical streaming data 136 and/or the additional data 306 to the machine learning models 302. The machine learning models 302 generate estimated streaming data 304 for respective media content items on the media content service provider system over a time period, such as for one or more minutes, one or more hours, one or more days, one or more weeks, one or more months, or any other time period. The machine learning engine 138 can send the estimated streaming data 304 to a payment service system for determining an estimated resource allocation to credit a balance of an account in advance for the time period.

Although the example environment 300 illustrates and describes using machine learning models 302 to obtain estimated streaming data 304, the example environment 300 may additionally, or alternatively, implement one or more other time-series forecasting techniques to obtain the estimated streaming data 304.

In the context of communication flow between an artist 116, a payment service system 120, one or more media content service provider systems 102, and a user 104, consider the following discussion.

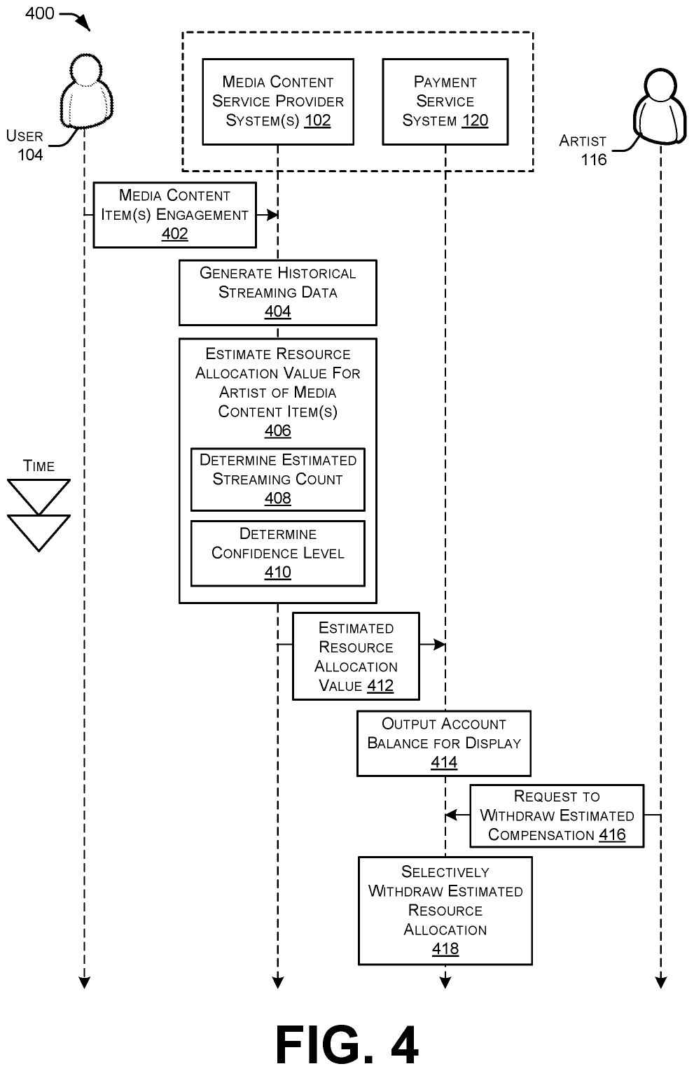

FIG. 4 is an illustration depicting a non-limiting example implementation showing operation of the media content service provider systems and the payment service system of FIG. 1 with a user and an artist in greater detail as facilitating the resource allocation based on the media content engagement in accordance with one or more implementations.

The example 400 includes a variety of example electronic communications and interactions (e.g., including control signals) between an artist 116, a payment service system 120, one or more media content service provider systems 102, and a user 104 over time. In this example 400, the electronic communications and interactions are positioned vertically based on time, such that electronic communications and interactions closer to a top of the example occur prior to electronic communications and interactions further from the top of the example. It follows also that electronic communications or interactions closer to a bottom of the example occur subsequent to electronic communications and interactions further from the bottom. In different implementations, such communications may occur in different orders than depicted in the example 400 without departing from the spirit or scope of the described techniques. Additionally, the electronic communications between the artist 116 and the payment service system 120 and between the user 104 and the media content service provider systems 102 are conducted using computing devices of the artist 116 and the user 104 (e.g., computing devices 108 as described with reference to FIG. 1), such as by using smart watches, mobile phones, laptops, and/or desktop computers of the artist 116 and the user 104.

In variations, the media content service provider systems 102 and/or the payment service system 120 are implemented at a single application, as described with reference to FIG. 1. Additionally, or alternatively, the media content service provider systems 102 and/or the payment service system 120 can be implemented at separate, or different, applications, as described with reference to FIG. 1. Aspects of the example 400 that are described as being performed by the media content service provider systems 102 may additionally, or alternatively, be performed by the payment service system 120.

At 402, a user 104 can engage with one or more media content items on one or more media content service provider systems 102. For example, the user 104 can listen to, view, or otherwise engage with a media content item (a music track, a music album, a playlist, a music video, etc.) published on the media content service provider systems 102. In one or more implementations, the user 104 can interact with an application on a computing device to engage with one or more media content items released to the media content service provider systems 102.

At 404, the media content service provider systems 102 generate historical streaming data from engagement with the media content items. The historical streaming data may be an example of the historical streaming data 136, as described with reference to FIGS. 1 and 2. For example, the historical streaming data includes historical streaming counts for respective media content items in respective media content libraries of the media content service provider systems 102 over a historical time period (a previous day, a previous week, a previous month, a previous year or set of years, etc.).

At 406, the media content service provider systems 102 estimate a resource allocation for an artist 116 of the media content items. Additionally, or alternatively, the media content service provider systems 102 estimate a resource allocation for another entity related to the artist 116 and/or the media content item (producer, distributor, songwriter, record label, band members, etc.). For example, at 408, the media content service provider systems 102 determine an estimated streaming count for one or more media content items of the artist 116. The media content service provider systems 102 can implement one or more machine learning models to estimate the streaming count over a time period (e.g., a day), as described with reference to FIG. 3. In some examples, the media content service provider systems 102 and/or the payment service system 120 determine an estimated pay rate from one or more historical pay rates for the media content items.

In some examples, at 410, the media content service provider systems 102 can determine a confidence level for the estimated resource allocation, as described with reference to FIG. 1. In some examples, the media content service provider systems 102 determine the confidence level based on a category of purchase (e.g., in the category of career advancements), a frequency of purchases, how often the user of the account withdraws an estimated resource allocation, a category of the artist 116 (a duration the artist 116 has been making music, a geographic location of the artist 116, one or more media content service provider systems 102 on which users engage with media content items of the artist 116, a distributor or record label the artist 116 uses, etc.), among other factors. For example, the media content service provider systems 102 can implement a model (e.g., machine learning models, probabilistic models, or any other models) to calculate a confidence interval. The media content service provider systems 102 can select a confidence level from the confidence interval that represents a risk level of the user of the account. The media content service provider systems 102 and/or the payment service system 120 can determine the estimated resource allocation from the estimated streaming count, the estimated pay rate, and the confidence level, as described with reference to FIG. 1.

At 412, the media content service provider systems 102 can send the estimated resource allocation to the payment service system 120. Additionally, or alternatively, the payment service system 120 can determine the estimated resource allocation. The payment service system 120 can facilitate an advance of funds that includes at least a portion of the estimated resource allocation to an account of the artist 116 and/or other user. The account has a stored balance that represents the balance of the account without the portion of the estimated resource allocation and a virtual balance that represents the balance of the account with the portion of the estimated resource allocation. In some examples, a third-party payment service can credit the stored balance of the account with a real resource allocation (e.g., a payment) periodically (e.g., after a time period). The payment service system 120 can facilitate the advance of funds including portions of the estimated resource allocation throughout the day. For example, the payment service system 120 can gradually credit and/or provide the balance of the account with the estimated resource allocation throughout the time period, such that a user of the account (e.g., the artist 116) can access the advanced funds (e.g., the estimated resource allocation) in real-time throughout the time period.

At 414, the payment service system 120 can output an account balance for display to a user of the account, which is described in further detail with respect to FIGS. 6 through 8. For example, the payment service system 120 can output the stored balance and the virtual balance for display via a user interface of a computing device. The payment service system 120 can update the displayed account balance in real-time throughout a time period (e.g., a day). For example, the payment service system 120 can output an account balance for display to show the artist 116 how much they are making over the course of the time period.

At 416, the payment service system 120 can receive a request (e.g., from the artist 116 and/or another user of an account) to withdraw at least a portion of the advance of funds, which can include an estimated resource allocation. For example, the request can include an indication of a value to withdraw from the balance, where the value includes a stored balance of the account and at least a portion of a virtual balance of the account. The artist 116 and/or other user of the account can trigger the request by using a payment instrument (e.g., swiping a credit or debit card for the account). The payment service system 120 receives a request to withdraw a value from the account via the payment instrument. The payment service system 120 evaluates transaction data including information indicating the value to determine whether to approve or deny the request in real-time based on the account balance. The transaction data can include, but is not limited to, engagement data for media content items related to the user of the account, how many times (e.g., a numerical quantity of withdrawals) a user of the account withdraws the estimated resource allocation, and/or additional data (charting data, playlisting data, fan engagement data, social media data, touring data, merchandise sales data, tip data, etc.).

At 418, the payment service system 120 can selectively withdraw the estimated resource allocation from the account. For example, the payment service system 120 can selectively withdraw at least the portion of the advance of funds that includes the estimated resource allocation from the account based on at least one of the historical streaming data, the confidence level, or one or more data sets. The one or more data sets include, but are not limited to, at least one of data related to a media content item from a media content service provider system application, data related to the media content item from a social platform application, data related to the artist 116 from the social platform application, or data that indicates additional resource allocation for the artist.

In some examples, selectively withdrawing at least the portion of the estimated resource allocation includes the payment service system 120 determining to withdraw at least the portion of the estimated resource allocation from the account if the historical streaming data satisfies a streaming threshold value, if the confidence level satisfies a confidence threshold value, and/or if respective data values for the one or more data sets satisfy at least one threshold value. In some other examples, selectively withdrawing at least the portion of the estimated resource allocation includes the payment service system 120 withholding withdrawal of (e.g., not withdrawing) at least the portion of the estimated resource allocation from the account based on the historical streaming data failing to satisfy a streaming threshold value, the confidence level failing to satisfy a confidence threshold value, and/or respective data values associated with the one or more data sets failing to satisfy at least one threshold value. The payment service system 120 can output a message for display at a computing device indicating the withholding of the withdrawal. For example, the message can include text (e.g., string values and/or character values) that indicate the withdrawal is withheld, denied, and/or not performed, as well as an indication of one or more threshold values (e.g., the streaming threshold value, the confidence threshold value, and/or the threshold value for the data sets) that are not satisfied.

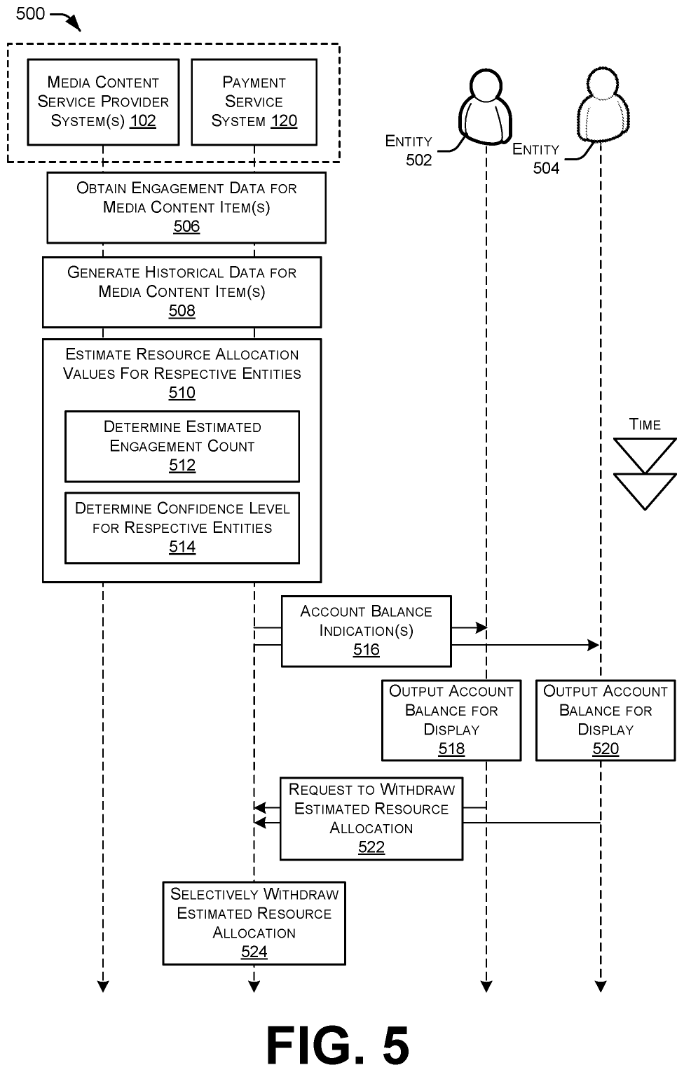

FIG. 5 is an illustration depicting a non-limiting example implementation showing operation of the media content service provider systems and the payment service system of FIG. 1 with multiple entities in greater detail as facilitating the resource allocation based on the media content engagement in accordance with one or more implementations.

The example 500 includes a variety of example electronic communications and interactions (e.g., including control signals) between an entity 502, an entity 504, the payment service system 120, and one or more media content service provider systems 102 over time. In this example 500, the electronic communications and interactions are positioned vertically based on time, such that electronic communications and interactions closer to a top of the example occur prior to electronic communications and interactions further from the top of the example. It follows also that electronic communications or interactions closer to a bottom of the example occur subsequent to electronic communications and interactions further from the bottom. In different implementations, such communications may occur in different orders than depicted in the example 500 without departing from the spirit or scope of the described techniques. Additionally, the electronic communications between the entity 502, the entity 504, and the payment service system 120 are conducted using computing devices of the entity 502 and the entity 504 (e.g., computing devices 108 as described with reference to FIG. 1), such as by using smart watches, mobile phones, laptops, and/or desktop computers of the entity 502 and the entity 504.

In variations, one or more media content service provider systems 102 and/or a payment service system 120 are implemented at a single application, as described with reference to FIG. 1. Additionally, or alternatively, the media content service provider systems 102 and/or the payment service system 120 can be implemented at separate, or different, applications, as described with reference to FIG. 1. Aspects of the example 500 that are described as being performed by the media content service provider systems 102 may additionally, or alternatively, be performed by the payment service system 120.

In some examples, the entity 502 and the entity 504 maybe involved in creation, publishing, or distribution of the media content items of the one or more media content service provider systems 102. Examples of the entity 502 and the entity 504 include, but are not limited to, artists (e.g., an artist 116, as described with reference to FIG. 1), producers, distributors, band members, songwriters, record labels, actors and actresses, athletes, crafts people, personalities, businesspeople, academics, fitness personalities, merchandisers, chefs, restauranteurs, facility or venue owners/engines, fashion designers, influencers, models, and promoters, to name just a few.

At 506, one or more media content service provider systems 102 and/or a payment service system 120 obtain engagement data for one or more media content items. For example, the media content service provider systems 102 collect data related to user engagement with the media content items on the media content service provider systems 102, user engagement with the media content items on another platform (e.g., a radio platform, a merchandise sales platform related to the media content items or an artist of the media content items, or a physical media content item sales platform, among other platforms), and user engagement with the media content items via purchase of tickets to a concert. The engagement data can include data related to actions of one or more users that causes the entity 502 and/or the entity 504 to earn a royalty payment. For example, the actions can include, but are not limited to, a user listening to, viewing, subscribing to, or otherwise engaging with a media content item (a music track, a music album, a playlist, a podcast, a music video, etc.) published on the media content service provider systems 102 or another platform, a user purchasing a physical media content item (a tape with a recorded media content item, a disk with a recorded media content item, a vinyl record with a recorded media content item, etc.), a user purchasing tickets to a live performance of the media content item, or a user purchasing merchandise related to the media content item or the artist of the media content item. In one or more implementations, the user can interact with an application on a computing device to engage with one or more media content items, where the engagement data includes application data that indicates user interaction with the application (streams of the media content items, purchases related to the media content item, etc.).

At 508, the media content service provider systems 102 and/or the payment service system 120 generate historical data for the one or more media content items from the engagement data for the media content items. The media content service provider systems 102 can transmit the engagement data to the payment service system 120 for generating the historical data to estimate resource allocations for respective entities (e.g., the entity 502 and the entity 504). Additionally, or alternatively, the media content service provider systems 102 can generate the historical data using the engagement data collected by the media content service provider systems 102 to estimate the resource allocations for the respective entities. The historical data may be an example of the historical streaming data 136, as described with reference to FIGS. 1 and 2. For example, the historical data includes historical streaming counts for respective media content items in a media content library of the media content service provider systems 102 over a historical time period (a previous day, a previous week, a previous month, a previous year or set of years, etc.). Additionally, or alternatively, the historical data can include historical purchase data of a physical media content item over a historical time period, historical purchase data of tickets (e.g., ticket sales data) over a historical time period for one or more live performances of the media content item, and/or historical purchase data of merchandise related to the media content item or the artist of the media content item over a historical time period.

At 510, the media content service provider systems 102 and/or the payment service system 120 estimate a resource allocation for respective entities, including the entity 502 and the entity 504. For example, the media content service provider systems 102 and/or the payment service system 120 can estimate a total resource allocation for one or more media content items and can divide or split the total resource allocation into one or more estimated resource allocations for the respective entities. Although two entities are shown (e.g., the entity 502 and the entity 504), the total resource allocation can be split into any numerical quantity of resource allocations for the respective entities. The media content service provider systems 102 and/or the payment service system 120 can determine respective percentages of an estimated total resource allocation to credit to respective accounts of the entity 502 and the entity 504. For example, an artist of the media content items can receive a first percentage of the total estimated resource allocation (e.g., 75% of the total estimated resource allocation), while a distributor can receive a second percentage of the total estimated resource allocation (e.g., 25% of the total estimated resource allocation). Similarly, a first band member of the media content items can receive a first percentage of the total estimated resource allocation (e.g., 15% of the total estimated resource allocation), a second band member of the media content items can receive a second percentage of the total estimated resource allocation (e.g., 15%, or any other percentage of the total estimated resource allocation), and so on. In some examples, the media content service provider systems 102 and/or the payment service system 120 determine the respective percentages by receiving user input indicating the respective percentages and/or by parsing data available to or stored at the media content service provider systems 102 to obtain the respective percentages. Additionally, or alternatively, the media content service provider systems 102 and/or the payment service system 120 can use one or more algorithms or models, such as the machine learning models as described with reference to FIG. 3, to analyze historical payment data for the media content items to determine the respective percentages.

At 512, the media content service provider systems 102 and/or the payment service system 120 determine an estimated engagement count (streaming count, purchase count, etc.) related to one or more media content items of an artist. The media content service provider systems 102 and/or the payment service system 120 can implement one or more machine learning models to estimate the engagement count over a time period (e.g., a day), as described with reference to FIG. 3. In some examples, the media content service provider systems 102 and/or the payment service system 120 determine an estimated pay rate from one or more historical pay rates for the media content items.

In some examples, at 514, the media content service provider systems 102 and/or the payment service system 120 can determine a confidence level for respective entities to determine the estimated resource allocation for the respective entities, as described with reference to FIG. 1. In some examples, the media content service provider systems 102 and/or the payment service system 120 determine the confidence level based on a category of purchase by the respective entities (e.g., in the category of career advancements), a frequency of purchases by the respective entities, how often the respective entities withdraw an estimated resource allocation from an account, a category of the respective entities (e.g., a type of the respective entities, a duration the respective entities have been involved in creation, distribution, etc. of media content items, a geographic location of the respective entities, a media content service provider system 102 on which users engage with media content items, a distributor or record label of the media content items, etc.), among other factors. For example, the media content service provider systems 102 can implement a model (e.g., machine learning models, probabilistic models, or any other models) to calculate a confidence interval. The media content service provider systems 102 can select a confidence level from the confidence interval that represents a risk level of the user of the respective entities. The media content service provider systems 102 and/or the payment service system 120 can determine the estimated resource allocation from the estimated streaming count, the estimated pay rate, and a confidence level for the artist, as described with reference to FIG. 1.

At 516, the payment service system 120 can transmit an account balance indication that indicates respective account balances (e.g., including respective estimated resource allocations) to the entity 502 and the entity 504. The payment service system 120 can facilitate an advance of funds to accounts of the entity 502 and the entity 504. The funds can include at least a portion of the estimated resource allocation for the entity 502 and the entity 504, respectively. The accounts have a stored balance that represents the balance of the accounts without the estimated resource allocation and a virtual balance that represents the balance of the accounts with the estimated resource allocation. In some examples, a third-party payment service can credit the stored balance of the accounts with a real resource allocation (e.g., a payment) periodically (e.g., after a time period). The payment service system 120 can facilitate the advance of funds to the balance of the accounts with portions of the estimated resource allocation throughout the day. For example, the payment service system 120 can gradually credit and/or provide the balance of the accounts with the estimated resource allocation throughout the time period, such that a user of the accounts (e.g., the entity 502 and the entity 504) can access the estimated resource allocation in real-time throughout the time period.

At 518 and at 520, devices (e.g., computing devices 108, as described with reference to FIG. 1) of the entity 502 and the entity 504, respectively, output an account balance for display to the entity 502 and the entity 504, which is described in further detail with respect to FIGS. 6 through 8. For example, the devices can output the stored balance and the virtual balance for display via user interfaces of the devices. The devices can update the displayed account balance in real-time throughout a time period (e.g., a day). For example, the devices can output an account balance for display to show the entity 502 and the entity 504 how much they are making over the course of the time period.

At 522, the payment service system 120 can receive a request (e.g., from the entity 502 and/or the entity 504) to withdraw at least a portion of the advance of funds, which can include an estimated resource allocation. For example, the request can include an indication of a value to withdraw from the balance, where the value includes a stored balance of the account and at least a portion of a virtual balance of the account. The entity 502 and/or the entity 504 can trigger the request by using a payment instrument (e.g., swiping a credit or debit card for the account). The payment service system 120 receives a request to withdraw a value from the account via the payment instrument. The payment service system 120 evaluates transaction data including information indicating the value to determine whether to approve or deny the request in real-time based on the account balance. The transaction data can include, but is not limited to, engagement data for media content items related to the user of the account (e.g., the entity 502 and/or the entity 504), how many times (e.g., a numerical quantity of withdrawals) a user of the account withdraws the estimated resource allocation, and/or additional data (e.g., charting data, playlisting data, fan engagement data, social media data, touring data, merchandise sales data, tip data, etc.).

At 524, the payment service system 120 can selectively withdraw the estimated resource allocation from an account of the entity 502 and/or an account of the entity 504. For example, the payment service system 120 can selectively withdraw at least the portion of the advance of funds that includes the estimated resource allocation from the accounts based on at least one of the historical streaming data, a confidence level for the artist, or one or more data sets. The one or more data sets include, but are not limited to, at least one of data related to a media content item from a media content service provider system application, data related to the media content item from a social platform application, data related to the entity 502 and/or the entity 504 from the social platform application, or data that indicates additional resource allocation for the entity 502 and/or the entity 504.

In some examples, selectively withdrawing at least the portion of the estimated resource allocation includes the payment service system 120 determining to withdraw at least the portion of the estimated resource allocation from the accounts if the historical streaming data satisfies a streaming threshold value, if the confidence level satisfies a confidence threshold value, and/or if respective data values for the one or more data sets satisfy at least one threshold value. In some other examples, selectively withdrawing at least the portion of the estimated resource allocation includes the payment service system 120 withholding withdrawal of (e.g., not withdrawing) at least the portion of the estimated resource allocation from the accounts based on the historical streaming data failing to satisfy a streaming threshold value, the confidence level failing to satisfy a confidence threshold value, and/or respective data values associated with the one or more data sets failing to satisfy at least one threshold value. The payment service system 120 can output a message for display at a computing device indicating the withholding of the withdrawal to the entity 502 and/or the entity 504. For example, the message can include text (e.g., string values and/or character values) that indicate the withdrawal is withheld, denied, and/or not performed, as well as an indication of one or more threshold values (e.g., the streaming threshold value, the confidence threshold value, and/or the threshold value for the data sets) that are not satisfied.

FIG. 6 is an illustration depicting a non-limiting example of a user interface configured to support display of an estimated resource allocation for resource allocation based on media content item engagement in accordance with one or more implementations.

The illustrated example 600 depicts a computing device 108 displaying a user interface 602 to a user (e.g., an artist 116 or other entity as described with reference to FIG. 1). For example, the user interface 602 displays an instance of an application, such as an application 106 as described with reference to FIG. 1. The application can be implemented by a payment service system and/or one or more media content service provider systems for advancing an estimated resource allocation to a balance 604 of an account. The account can be a user account 606 of an artist, such as an artist A, and/or of one or more entities (e.g., producers, distributors, songwriters, and record labels). The user interface 602 displays a value of a balance 604, such as one or more string and/or character values that recite “Current Balance,” and a total, such as “Total: $100.00.”

In variations, the user interface 602 displays one or more different balances that make up the balance 604 (e.g., a total current balance of the user account 606). For example, the balance 604 of the user account 606 includes a stored balance and an estimated resource allocation balance. The stored balance can include a monetary value (e.g., $76) of the total balance 604 that is credited to the user account 606 prior to an advanced payment for an estimated resource allocation. The estimated resource allocation can include a monetary value (e.g., $26) that represents a virtual balance that is advanced to the user account 606 prior to a transfer of a resource allocation from a third-party payment service, as described with reference to FIG. 2. For example, the artist A is supplied a dashboard via the user interface 602 that displays an estimated resource allocation that the artist A is expected to have earned over a time period based on the predicted streaming counts and historical pay rate. The estimated resource allocation is updated in real-time or in near-real-time to compensate the artist A for estimated streaming or engagement with media content items of the artist A. The artist A is provided access to at least a portion of the estimated resource allocation over the time period as an “advance” that the artist A can use on whatever they want to spend on (groceries, studio time, instruments, etc.). The estimated resource allocation is provided to a user account 606 that the artist A has access to, such as via a debit card or other payment instrument. When the artist A makes a purchase for a value, a query is made to determine if the artist has a sufficient balance 604 (e.g., the balance 604 satisfies the value) to make the purchase.

In variations, the user interface 602 includes one or more notifications 608 for display to a user (e.g., artist A). The notifications 608 can include one or more string and/or character values output in the form of a message to the user. The message can include one or more feedback messages related to an estimated resource allocation for one or more media content items related to the user. For example, the message can include a text value of “Looks like your fans love your latest release! Keep up the great work.” Although the example text value includes positive encouragement for the user of the account, the message can include any text value, or other value that indicates feedback to the user (e.g., positive feedback, neutral feedback, and/or negative feedback). The application can select a text value to display as a notification 608 from a defined or configured list of text values based on one or more engagement thresholds values. For example, if the estimated resource allocation for one or more media content items of the artist A satisfies a threshold value, then the application can select a positive feedback message from the list of text values to display via the user interface 602. Additionally, or alternatively, if the estimated resource allocation for one or more media content items of the artist A fails to satisfy a threshold value and/or equals a threshold value, then the application can select a negative feedback message and/or a neutral feedback message from the list of text values to display via the user interface 602.

The notifications 608 can include a display of an estimated streaming count for one or more media content items of the artist A and/or one or more engagement metrics for the media content items of the artist A. The engagement metrics can include an average historical streaming count for a time period, such as a day. For example, the notifications 608 can include the value “Today's Engagement: 1000 Listens,” and/or “Average Daily Engagement: 700 Listens,” where the estimated streaming count over a time period for the media content items is 1000 and the average historical streaming count over one or more previous time periods is 700. The application can additionally, or alternatively, obtain information related to respective media content items, which can be searchable by the artist A, which is described in further detail with respect to FIGS. 7 and 8.

In variations, one or more media content service provider systems and/or payment service system accesses a recoupment process status for the estimated resource allocation through the user account 606. In some examples, the user interface 602 can include a selectable option for a user of the user account 606 (e.g., the artist A) to provide an indication of one or more additional resource allocations to be credited to or withdrawn from the balance 604 that may not be indicated by the user account 606.

FIG. 7 is an illustration depicting a non-limiting example of a user interface configured to support search of a media content item for display of resource allocation based on media content item engagement in accordance with one or more implementations.

The illustrated example 700 depicts a computing device 108 displaying a user interface 702 to a user (e.g., an artist 116 or other entity as described with reference to FIG. 1). For example, the user interface 702 displays an instance of an application, such as an application 106 as described with reference to FIG. 1. The application can be implemented by a payment service system and/or one or more media content service provider systems for advancing an estimated resource allocation to a balance of an account. The account can be a user account 706 of an artist, such as an artist A, and/or of one or more entities (e.g., producers, distributors, songwriters, and record labels).

A user can interact with a search feature 708 of the user interface 704 to input a string value and/or a character value. In variations, the user inputs a string value into the search feature 708 when searching for a media content item (e.g., a name of a media content item). The application can obtain a list of media content items that the artist A is compensated for (e.g., earns royalties for). The application can display a title of the media content item (e.g., Media Content Item A and/or Media Content Item B) and one or more balances related to respective media content items via the user interface 702. The list can be sorted and/or ranked by the title of the media content items and/or one or more balances associated with the media content items. The balances can include a total resource allocation for a media content item and an estimated resource allocation for the media content item. For example, for the media content item A, the total resource allocation can include a balance of “$25.00,” where an estimated resource allocation can include a balance of “$2.00.” In some other examples, for the media content item B, the total resource allocation can include a balance of “$5.00,” where an estimated resource allocation can include a balance of “$3.50.” The total resource allocation can include a resource allocation received at the user account 706 over a historical time period (e.g., the duration that the media content item has been earning resource allocation). The estimated resource allocation can include at least a portion of an estimated resource allocation for a current or future time period (e.g., earned throughout a day, week, month, year, etc.), which is updated in real-time or near-real-time.

FIG. 8 is an illustration depicting a non-limiting example of a user interface configured to support display of ranked media content item engagement in accordance with one or more implementations.

The illustrated example 800 depicts a computing device 108 displaying a user interface 802 to a user (e.g., an artist 116 or other entity as described with reference to FIG. 1). For example, the user interface 802 displays an instance of an application, such as an application 106 as described with reference to FIG. 1. The application can be implemented by a payment service system and/or one or more media content service provider systems for advancing an estimated resource allocation to a balance of an account. The account can be a user account 806 of an artist, such as an artist A, and/or of one or more entities (e.g., producers, distributors, songwriters, and record labels).

In variations, the user interface 802 displays a ranked list 804 of one or more media content items. The media content items can be ranked based on a numerical quantity of listens (e.g., streams) of the media content items. The numerical quantity of listens or streams can include a historical streaming count over a previous time period, a total historical streaming count, and/or an estimated streaming count for a future time period. The ranked list 804 can be updated in real-time or in near-real-time according to the estimated streaming count.

In some examples, the user interface 802 additionally, or alternatively, includes interactive elements, such as one or more selectable features 808 (e.g., selectable buttons, drop-down menus, etc.) to indicate to the computing device 108 to display one or more engagement metrics for different media content items (e.g., the media content item A through the media content item E). The engagement metrics can include a total streaming count for the media content item, a streaming count of the media content item over a historical time period, a streaming count of the media content item over a future time period, one or more geographic locations of streaming for the media content item, or any other information related to streaming of the media content item.

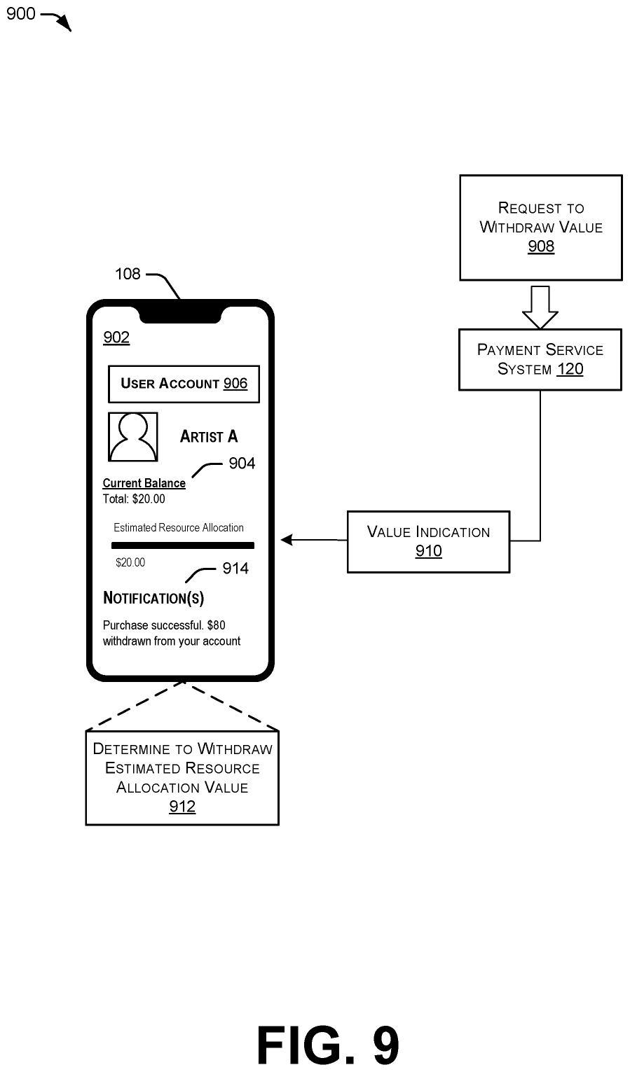

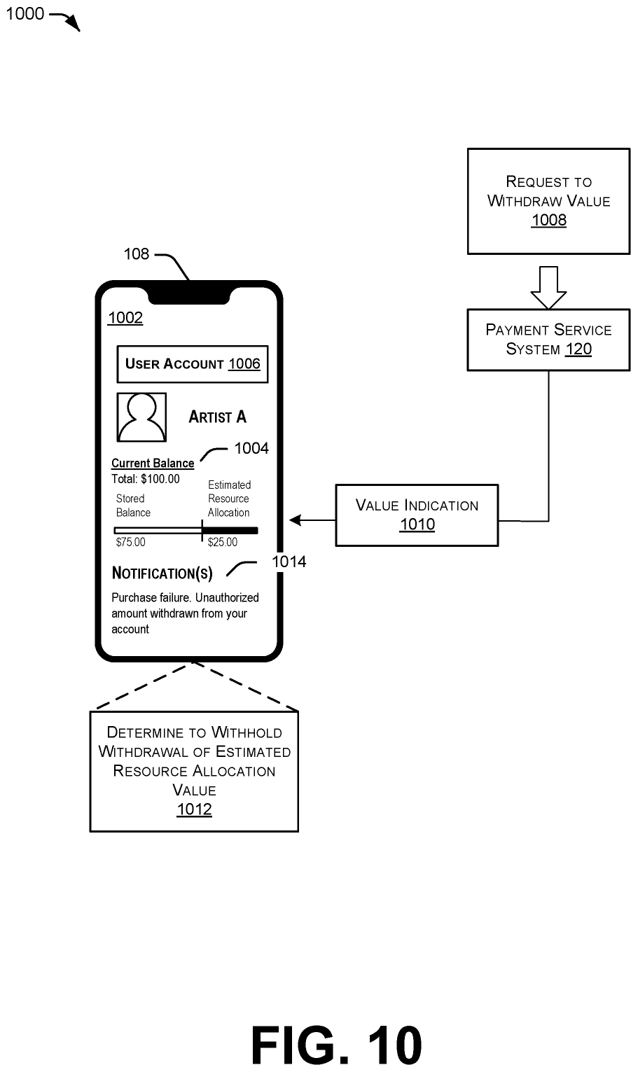

FIG. 9 is a non-limiting example of a system showing a determination to withdraw resources allocated to an account in accordance with one or more implementations.

The illustrated example 900 depicts a computing device 108 displaying a user interface 902 to a user (e.g., an artist 116 or other entity as described with reference to FIG. 1). For example, the user interface 902 displays an instance of an application, such as an application 106 as described with reference to FIG. 1. The application can be implemented by a payment service system 120 (e.g., a payment service system 120 as described with reference to FIGS. 1 and 4) and/or one or more media content service provider systems for advancing an estimated resource allocation to a balance 904 of an account. The account can be a user account 906 of an artist, such as an artist A, and/or of one or more entities (e.g., producers, distributors, songwriters, and record labels).

In variations, the balance 904 includes a stored balance and an estimated resource allocation, as described with reference to FIG. 6. For example, the stored balance can include $75, and the estimated resource allocation can include $25. In some examples, a payment service system 120 receives transaction data indicating a request to withdraw a value from the current balance 904 of the user account 906. For example, the payment service system 120 receives a request to withdraw a value 908. The transaction data can include information for purchase of a service and/or a good using a payment instrument, such as a value of the purchase and a merchant, among other information. The payment service system 120 can compare the value to a current balance 904 of the user account 906 (e.g., $100). If the balance 904 is greater than or exceeds the value, then the payment service system 120 can indicate the value to the computing device 108 to withdraw from the current balance 904. For example, the payment service system 120 transmits a value indication 910 to the instance of the application at the computing device 108.

In variations, a stored balance is withdrawn from a balance 904 of the user account 906 prior to an estimated resource allocation. Thus, withdrawing the value can include withdrawing the stored balance and at least a portion of the estimated resource allocation if the value exceeds the stored balance. For example, if the user account has $100, as described with reference to FIG. 6, and the value is $90, then the stored balance of $75 is withdrawn prior to the $5 of the $25 included in the estimated resource allocation.

In some cases, the computing device 108 determines whether to withdraw the value from the balance 904 and update the instance of the application to display an updated balance (e.g., $20). For example, the computing device 108 and/or the payment service system 120 determines to withdraw at least the portion of the estimated resource allocation from the account if historical streaming data satisfies a streaming threshold value, if a confidence level satisfies a confidence threshold value, and/or if respective data values for one or more data sets satisfy at least one threshold value, as described with reference to FIG. 4. If the payment service system 120 makes the determination, then the payment service system 120 indicates the determination to the computing device 108 in the value indication 910. In some other examples, at 912, the computing device 108 determines to withdraw the estimated resource allocation and update the instance of the application to display the updated balance.

The computing device 108 can update the user interface 902 to display an instance of the application that includes an updated balance. For example, the user interface 902 displays a value of a balance 904 in real-time, such as one or more string and/or character values that recite “Current Balance,” and a total, such as “Total: $20.00.” Additionally, or alternatively, the user interface 902 includes one or more notifications 914 for display to a user (e.g., artist A). The notifications 914 can include one or more string and/or character values output in the form of a message to the user. The message can include one or more feedback messages related to whether the transaction is successful, and the value is withdrawn from the balance 904. For example, the message can include a text value of “Purchase successful. $90 withdrawn from your account.”

FIG. 10 is a non-limiting example of a system showing a determination to withhold withdrawal of resources allocated to an account in accordance with one or more implementations.

The illustrated example 1000 depicts a computing device 108 displaying a user interface 1002 to a user (e.g., an artist 116 or other entity as described with reference to FIG. 1). For example, the user interface 1002 displays an instance of an application, such as an application 106 as described with reference to FIG. 1. The application can be implemented by a payment service system 120 (e.g., a payment service system 120 as described with reference to FIGS. 1 and 4) and/or one or more media content service provider systems for advancing an estimated resource allocation to a balance 1004 of an account. The account can be a user account 1006 of an artist, such as an artist A, and/or of one or more entities (e.g., producers, distributors, songwriters, and record labels).

In variations, the balance 1004 includes a stored balance and an estimated resource allocation, as described with reference to FIG. 6. For example, the stored balance can include $75, and the estimated resource allocation can include $25. In some examples, a payment service system 120 receives transaction data indicating a request to withdraw a value from the current balance 1004 of the user account 1006. For example, the payment service system 120 receives a request to withdraw a value 1008. The transaction data can include information for purchase of a service and/or a good using a payment instrument, such as a value of the purchase and a merchant, among other information. The payment service system 120 can compare the value to a current balance 1004 of the user account 1006 (e.g., $100). If the balance 1004 is less than the value, then the payment service system 120 can indicate the value to the computing device 108 in a value indication 1010, along with a message requesting for the computing device 108 to withhold withdrawal or refrain from withdrawing the value from the balance 1004.

In some other examples, the payment service system 120 determines that the balance 1004 is greater than or exceeds the value, but that the stored balance is less than the value, where the stored balance is withdrawn from the balance 1004 prior to the estimated resource allocation. The payment service system 120 can compare information related to the artist A and/or to the media content items to one or more threshold values to determine whether to approve withdrawal of the difference between the value and the stored balance from the estimated resource allocation (e.g., at least a portion of the estimated resource allocation). For example, the payment service system 120 can determine whether historical streaming data satisfies a streaming threshold value, if a confidence level satisfies a confidence threshold value, and/or if respective data values for one or more data sets satisfy at least one threshold value, as described with reference to FIG. 4. If the threshold values are satisfied, then the payment service system 120 can withdraw the value from the balance 1004 and/or can transmit the value indication 1010 to the computing device 108 to indicate the value to withdraw from the balance 1004. If the threshold values are not satisfied, then the payment service system 120 can indicate the value to the computing device 108 in the value indication 1010, along with a message requesting for the computing device 108 to withhold withdrawal or refrain from withdrawing the value from the balance 1004.

Additionally, or alternatively, if the payment service system 120 determines that the balance 1004 is greater than or exceeds the value, but that the stored balance is less than the value, then the payment service system 120 can transmit the value indication 1010 to the computing device 108 indicating the value. The computing device 108 can compare information related to the artist A and/or to the media content items to the threshold values to determine whether to approve withdrawal of the difference between the value and the stored balance from the estimated resource allocation. In some examples, such as if the threshold values are not satisfied, at 1012, the computing device 108 determines to withhold withdrawal of the estimated resource allocation (e.g., the difference between the value and the stored balance from the estimated resource allocation). Additionally, or alternatively, the computing device 108 determines to withhold withdrawal of the estimated resource allocation based on a message in the value indication 1010 from the payment service system 120 indicating for the computing device 108 to withhold withdrawal of the estimated resource allocation or to refrain from withdrawing the estimated resource allocation. In some examples, if the computing device 108 and/or the payment service system 120 withholds withdrawal or refrains from withdrawing from the estimated resource allocation, then the computing device 108 and/or the payment service system 120 can indicate to a merchant device to cancel the data transaction.

The computing device 108 can update the user interface 1002 to display an instance of the application that includes a balance 1004 that is not updated to withdraw the value and a message that the withdrawal is withheld. For example, the user interface 1002 displays a value of a balance 1004 in real-time, such as one or more string and/or character values that recite “Current Balance,” and a total, such as “Total: $100.00.” Additionally, or alternatively, the user interface 1002 includes one or more notifications 1014 for display to a user (e.g., artist A). The notifications 1014 can include one or more string and/or character values output in the form of a message to the user, such as a feedback message indicating whether the transaction is successful. For example, the message can include a text value of “Purchase failure. Unauthorized amount withdrawn from your account.” In variations, if the computing device 108 determines to withhold the withdrawal of the estimated resource allocation, then the computing device 108 can transmit an indication to the payment service system 120 indicating the purchase failure and/or withholding of the withdrawal.

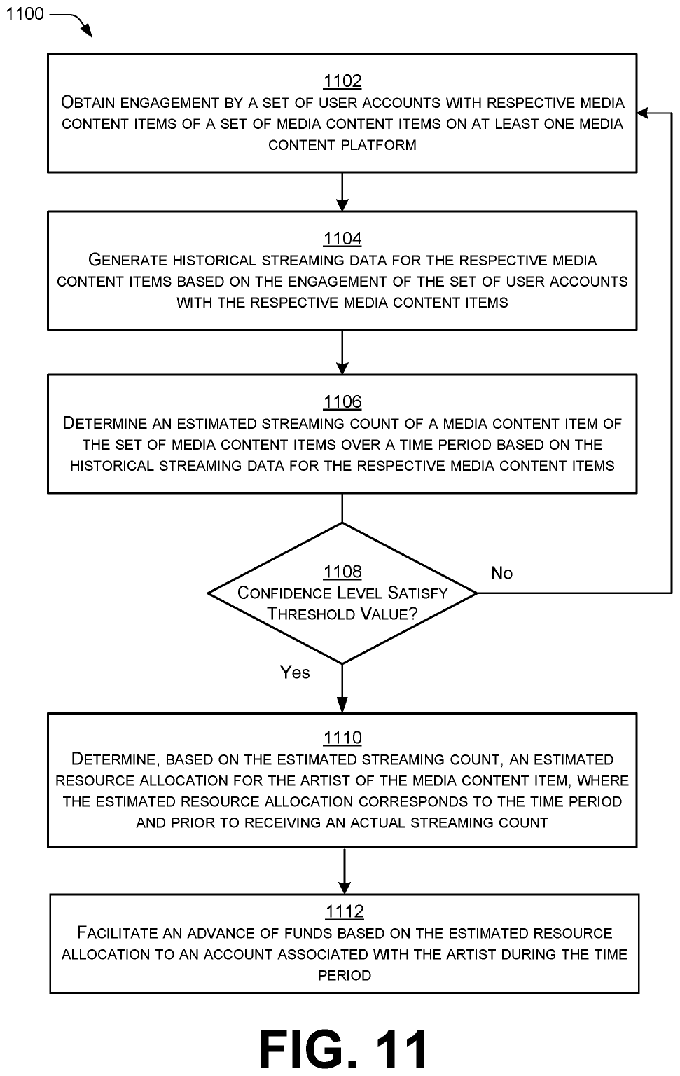

FIG. 11 is a flow diagram depicting a step-by-step procedure in an example implementation of operations performable by a processing device for facilitating resource allocation to an account for media content item engagement in accordance with one or more implementations.

At 1102, engagement by a set of user accounts with respective media content items of a set of media content items on at least one media content service provider system is obtained.

At 1104, historical streaming data for the respective media content items is generated based on the engagement of the set of user accounts with the respective media content items. In some examples, the historical streaming data includes at least one of streaming data for respective artists of the set of media content items, calendar information associated with the time period, artist information for the respective artists, or a condition related to at least one media content item of the set of media content items (e.g., current events or other news events related to at least one media content item of the media content items).

At 1106, an estimated streaming count of a media content item of the set of media content items over a time period is determined based on the historical streaming data for the respective media content items. The estimated streaming count is generated by at least one machine learning model based on inputting the historical streaming data to the at least one machine learning model, as described with reference to FIG. 3. The at least one machine learning model is trained to generate the estimated streaming count using the historical streaming data. An indication is received that indicates at least one of an actual streaming count of the media content item or a resource allocation for the actual streaming count of the media content item. One or more parameters of the at least one machine learning model are updated based on the at least one of the actual streaming count of the media content item or the resource allocation for the actual streaming count of the media content item.

In some examples, a confidence interval for an estimated resource allocation for the media content items is determined based on one or more data sets. A size of the confidence interval is based on at least one of a numerical quantity of data values in the one or more data sets or a variability of respective data in the one or more data sets. A confidence level for the estimated resource allocation is selected from the confidence interval. In some examples, the one or more data sets include at least one of a time series history of a resource allocation for an actual streaming count of the respective media content items, a set of categories of the respective media content items, the actual streaming count of the respective media content items, the historical streaming data for the respective media content items, a geographic location of the set of user accounts, a geographic location of a set of artists of the respective media content items, and/or a frequency of release of media content items for respective artists of the set of artists. In some cases, the account has a first stored balance and a second stored balance. The first stored balance includes the estimated resource allocation, which may be referred to as a virtual balance. The second stored balance includes a balance prior to receiving an estimated resource allocation, which may be referred to as a stored balance. Selecting the confidence level may be based on a numerical quantity of times a value withdrawn from the account exceeds the second stored balance over an additional time period.

In some examples, at 1108, a determination is made by a payment service and/or the media content service provider system about whether the confidence level satisfies a threshold value. If not (e.g., “No”), then the payment service and/or the media content service provider system can continue to monitor engagement by the set of user accounts with respective media content items of the set of media content items on the media content service provider system. If the confidence level satisfies the threshold value (e.g., “Yes”), then at 1110, an estimated resource allocation for the artist of the media content item is determined based on the estimated streaming count.

At 1112, an advance of funds based on the estimated resource allocation is facilitated to an account associated with the artist. In some cases, an account balance of the account is output for display at a computing device in real-time, as described with reference to FIG. 6. The account balance includes the advance of funds (e.g., including at least a portion of the estimated resource allocation).

In some examples, a request to withdraw at least a portion of the advance of funds from the account is received by the payment service and/or the media content service provider system. The payment service can selectively withdraw at least the portion of the advance of funds from the account based on at least one of the historical streaming data, the confidence level, or one or more data sets. The one or more data sets include, but are not limited to, at least one of data related to the media content item from a media content service provider system application, data related to the media content item from a social platform application, data related to the artist from the social platform application, or data that indicates additional resource allocation for the artist. For example, the one or more data sets can include charting data, playlisting data, fan engagement data, social media data, touring data, merchandise sales data, tip data, and/or any third-party publicly provided data sources.

In some examples, selectively withdrawing at least the portion of the advance of funds includes withdrawing at least the portion of the advance of funds from the account based on at least one of the historical streaming data satisfying a streaming threshold value, the confidence level satisfying a confidence threshold value, or respective data values associated with the one or more data sets satisfying at least one threshold value. In some other examples, selectively withdrawing at least the portion of the advance of funds includes withholding withdrawal of at least the portion of the advance of funds from the account based on at least one of the historical streaming data failing to satisfy a streaming threshold value, the confidence level failing to satisfy a confidence threshold value, or respective data values associated with the one or more data sets failing to satisfy at least one threshold value and outputting, for display at a computing device, a message indicating the withholding of the withdrawal.

In some examples, the account is associated with a payment service. The payment service and the media content service provider system are associated with an instance of an application. For example, the payment service and the media content service provider system are implemented by a same application.

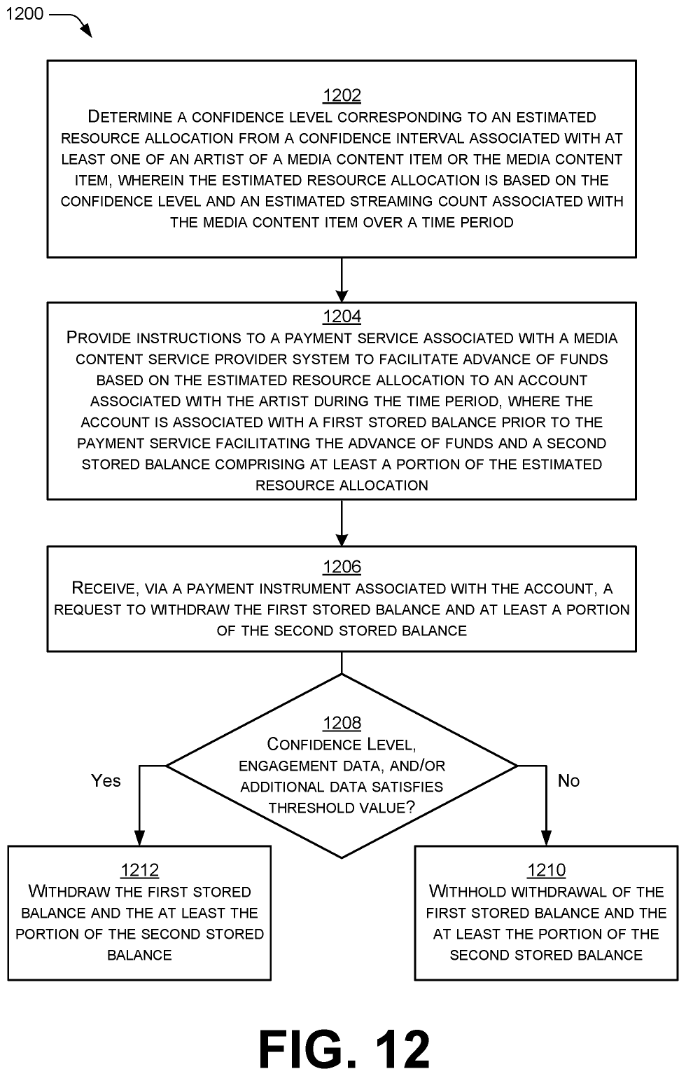

FIG. 12 is a flow diagram depicting a step-by-step procedure in an example implementation of operations performable by a processing device for determining whether to withdraw resources allocated to an account for media content item engagement in accordance with one or more implementations.

At 1202, a confidence level corresponding to an estimated resource allocation from a confidence interval for at least one of an artist of a media content item or the media content item is determined. The estimated resource allocation is based on the confidence level and an estimated streaming count associated with the media content item over a time period.

At 1204, instructions are provided to a payment service implemented by a media content service provider system to facilitate advance of funds based on the estimated resource allocation to an account associated with the artist during the time period. The account includes a first stored balance prior to the payment service facilitating the advance of funds (e.g., a stored balance) and a second stored balance that includes the at least the portion of the estimated resource allocation (e.g., a virtual balance).

At 1206, a request to withdraw the first stored balance and at least a portion of the second stored balance is received via a payment instrument for the account.

In some examples, at 1208, a determination is made by a payment service and/or the media content service provider system about whether the confidence level, engagement data, and/or additional data satisfies a threshold value. If not (e.g., “No”), then at 1210 withdrawal of the first stored balance and the at least the portion of the second stored balance is withheld. If the confidence level satisfies the threshold value (e.g., “Yes”), then at 1212, the first stored balance and the at least the portion of the second stored balance are withdrawn.

In some examples, determining to withdraw the first stored balance and at least the portion of the second stored balance from the account is based on at least one of engagement data of a set of user accounts related to the media content item, the confidence level, or respective data values in one or more data sets. The one or more data sets include at least one of data related to the media content item from a media content service provider system application, data related to the media content item from a social platform application, data for the artist from the social platform application, or data that indicates additional resource allocation for the artist. For example, the one or more data sets can include charting data, playlisting data, fan engagement data, social media data, touring data, merchandise sales data, tip data, and/or any third-party publicly provided data sources.

In some examples, the first stored balance and the second stored balance is output for display at a computing device in real-time based on the payment service crediting the account. The confidence level is based on at least one of a time series history of a resource allocation for a streaming count of respective media content items on the media content service provider system, a set of categories corresponding to the respective media content items, the streaming count of the respective media content items, historical streaming data for the respective media content items, a geographic location of a plurality of user accounts associated with the media content service provider system, a geographic location of a set of artists of the respective media content items, or a frequency of release of media content items from respective artists of the set of artists.

In some examples, the account is associated with a payment service. The payment service and the media content service provider system are associated with an instance of an application. For example, the payment service and the media content service provider system are implemented by a same application.

FIG. 13 is a non-limiting example illustrating an environment in which resource allocation based on media content item engagement techniques described herein are performed in accordance with one or more implementations. The environment 1300 includes server(s) 1302 that can communicate over a network 1304 with end user devices 1306 and/or server(s) 1308 associated with third-party service provider(s). In various examples, the end user devices 1306 may comprise one or more seller devices 1306(A), one or more user devices 1306(B) and/or 1306(C) in a peer network, one or more content consumption devices 1306(D), one or more artist devices 1306(E), combinations of these examples, or other categories of user devices. The server(s) 1302 can be associated with one or more service providers that can provide one or more services for the benefit of users 1316, as described below. For example, the server(s) 1302 may enable services of service providers such as in association with a seller platform 1310 (which may further include a buyer platform), a P2P payment platform 1312, a media content service provider system 1314, a combination of these platforms, or other platforms associated with other service providers. While services and features are referenced throughout in connection with a particular one of the seller platform 1310, the P2P payment platform 1312, or the media content service provider system 1314, it should be understood that any of these platforms may perform the functionality described in relation to any of the other platforms. Actions attributed to the service provider(s) can be performed by the server(s) 1302.

In the context of the previously described figures, for example, at least a portion of the server(s) 1302 may be used to implement the engagement platform 126 and/or various portions of the one or more media content service provider systems 102.

In some examples, individual ones of the end user devices 1306 can be operable by users 1316. The users 1316 (individually referred to herein as “user 1316”) can be referred to as customers, buyers, merchants, sellers, borrowers, employees, employers, payors, payees, couriers, artists, musicians, listeners, fans, supervisors, hosts, audience members, and so on. The users 1316 can interact with the end user devices 1306 via user interfaces presented via the end user devices 1306. In at least one example, a user interface can be presented via a web browser, or the like. Alternatively, or additionally, a user interface can be presented via an application, such as a mobile application or desktop application, which can be provided by the seller platform 1310, the P2P payment platform 1312, and/or the media content service provider system 1314, or which can be an otherwise dedicated application. In some examples, individual end user devices 1306 can have an instance or versioned instance of an application, which can be downloaded from an application store, for example, which can present the user interface(s) described herein.

In at least one example, the users 1316 can include merchants that can operate the seller device(s) 1306(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1306(A) can have an instance of a point of sale (“POS”) application 1320 stored thereon. The POS application 1320 can configure the seller device 1306(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1320 can determine transaction data associated with the POS transactions. Transaction data can include payment information, which can be obtained from a reader device 1322 associated with the seller device 1306(A), user authentication data, purchase amount information, point-of-purchase information (e.g., item(s) purchased, date of purchase, time of purchase, subscription type, etc.), etc. The POS application 1320 can send transaction data to the server(s) 1302 such that the server(s) 1302 can track transactions of the customers, merchants, and/or the users 1316 over time. Furthermore, the POS application 1320 can present a UI to enable the merchant to interact with the POS application 1320 and/or the seller platform 1310 via the POS application 1320.

In at least one example, the seller device 1306(A) can be a special-purpose computing device configured as a POS terminal (via the execution of the POS application 1320). In at least one example, the POS terminal may be connected to a reader device 1322, which is capable of accepting a variety of payment instruments, such as credit cards, debit cards, gift cards, short-range communication-based payment instruments, and the like, as described below. In at least one example, the reader device 1322 can plug in to a port in the seller device 1306(A), such as a microphone port, a headphone port, an audio-jack, a data port, or other suitable port. In additional or alternative examples, the reader device 1322 can be coupled to the seller device 1306(A) via another wired or wireless connection, such as via Bluetooth®, BLE, and so on. In some examples, the reader device 1322 can be a software solution executing on the POS terminal, e.g., a mobile phone. In some examples, the reader device 1322 can read information from alternative payment instruments including, but not limited to, wristbands and the like.

In some examples, the reader device 1322 may physically interact with payment instruments such as magnetic stripe payment cards, EMV payment cards, and/or short-range communication (e.g., near field communication (NFC), radio frequency identification (RFID), Bluetooth®. Bluetooth® low energy (BLE), etc.) payment instruments (e.g., cards, hardware wallets, fobs, or devices configured for tapping). The POS terminal may provide a rich user interface, communicate with the reader device 1322, and communicate with the seller platform 1310, which can provide, among other services, a payment processing service. The server(s) 1302 associated with the seller platform 1310 can communicate with server(s) 1308, as described below. In this manner, the POS terminal and reader device 1322 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1322 of the POS system 1324 are shown as separate devices, in additional or alternative examples, the POS terminal and the reader device 1322 can be part of a single device. In some examples, the reader device 1322 can have a display integrated therein for presenting information to customers of a merchant. In additional or alternative examples, the POS terminal can have a display integrated therein for presenting information to the customers of the merchant. POS systems, such as the POS system 1324, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1322, whereby the reader device 1322 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1324, the server(s) 1302, and/or the server(s) 1308 may exchange payment information and transaction data to determine whether transactions are authorized. For example, the POS system 1324 may provide encrypted payment data, user authentication data, purchase amount information, point-of-purchase information, etc. (collectively, transaction data) to server(s) 1302 over the network(s) 1304. The server(s) 1302 may send the transaction data to the server(s) 1308.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1308 associated therewith) can forward the fund transfer request to an issuing bank (e.g., “issuer”). The issuer is a bank or financial institution that offers a financial account (e.g., credit or debit card account) to a user. The issuer (e.g., the server(s) 1308 associated therewith) can make a determination as to whether the customer has the capacity to absorb the relevant charge associated with the payment transaction. In at least one example, the seller platform 1310 can serve as an issuer and/or can partner with an issuer. The transaction is either approved or rejected by the issuer and/or the card payment network (e.g., the server(s) 1308 associated therewith), and a payment authorization message is communicated from the issuer to the POS device via a path opposite of that described above, or via an alternate path.

The server(s) 1308 may send an authorization notification over the network(s) 1304 to the server(s) 1302, which may send the authorization notification to the POS system 1324 over the network(s) 1304 to indicate whether the transaction is authorized. The server(s) 1302 may also transmit additional information such as transaction identifiers to the POS system 1324. In one example, the server(s) 1302 may include a merchant application and/or other functional components for communicating with the POS system 1324 and/or the server(s) 1308 to authorize or decline transactions (e.g., the API 1318). In examples, the seller platform 1310 can enable the merchants to receive cash payments, payment card payments, and/or electronic payments from customers for POS transactions and the service provider can process transactions on behalf of the merchants.

Based on the authentication notification that is received by the POS system 1324 from server(s) 1302, the merchant may indicate to the customer whether the transaction has been approved. In some examples, approval may be indicated at the POS system 1324, for example, at a display of the POS system 1324. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The seller platform 1310 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the user devices 1306 can access all of the services. In some cases, the user devices 1306 can have gradated access to the services, which can be based on risk tolerance, IDV outputs, subscriptions, and so on. In at least one example, access to such services can be availed to the merchants via the POS application 1320. In additional or alternative examples, various services can be associated with their own access point (e.g., application, web browser, etc.).

As the seller platform 1310 processes transactions on behalf of the merchants, the seller platform 1310 can maintain accounts or balances for the merchants in one or more ledgers. For example, the seller platform 1310 can analyze transaction data received for a transaction to determine an amount of funds owed to a merchant for the transaction and deposit funds into an account of the merchant. The account can have a stored balance, which can be managed by the seller platform 1310. The account can be different from a conventional bank account at least because the stored balance is managed by a ledger of the seller platform 1310 and the associated funds are accessible via various withdrawal channels including, but not limited to, scheduled deposit, same-day deposit, instant deposit, and a linked payment instrument.

A scheduled deposit can occur when the seller platform 1310 transfers funds associated with a stored balance of the merchant to a bank account of the merchant that is held at a bank or other financial institution (e.g., associated with the server(s) 1308). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the seller platform 1310 to the bank account of the merchant.

In at least one example, the seller platform 1310 may provide inventory management services. That is, the seller platform 1310 may provide inventory tracking and reporting. Inventory management services may enable the merchant to access and manage a database storing data associated with a quantity of items that the merchant has available (i.e., an inventory). Furthermore, in at least one example, the seller platform 1310 can provide catalog management services to enable the merchant to maintain a catalog, which can be a database storing data associated with items that the merchant has available for acquisition (i.e., catalog management services). The seller platform 1310 can offer recommendations related to pricing of the items, placement of items on the catalog, and multi-party fulfillment of the inventory, to name a few examples.

In at least one example, the seller platform 1310 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the seller platform 1310 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the seller platform 1310 can provide financing services for offering and/or lending a loan to a borrower that is to be used for, in some instances, financing the borrower's short-term operational needs (e.g., a capital loan). Additionally or alternatively, the seller platform 1310 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The seller platform 1310 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The seller platform 1310 can provide web-development services, which enable users 1316 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the seller platform 1310 can recommend and/or generate content items to supplement omni-channel presences of the merchants.

Furthermore, the seller platform 1310 can provide payroll services to enable employers to pay employees for work performed on behalf of employers. In at least one example, the seller platform 1310 can receive data that includes time worked by an employee (e.g., through imported timecards and/or POS interactions), sales made by the employee, gratuities received by the employee, and so forth. Based on such data, the seller platform 1310 can make payroll payments to employee(s) on behalf of an employer via the payroll service. For instance, the seller platform 1310 can facilitate the transfer of a total amount to be paid out for the payroll of an employee from the bank of the employer to the bank of the seller platform 1310 to be used to make payroll payments. In at least one example, when the funds have been received at the bank of the seller platform 1310, the seller platform 1310 can pay the employee, such as by check or direct deposit.

Moreover, in at least one example, the seller platform 1310 can provide employee management services for managing schedules of employees. Further, the seller platform 1310 can provide appointment services for enabling users 1316 to set schedules for scheduling appointments and/or users 1316 to schedule appointments.

In some examples, the seller platform 1310 can provide restaurant management services to enable users 1316 to make and/or manage reservations, to monitor front-of-house and/or back-of-house operations, and so on. In such examples, the seller device(s) 1306(A) and/or server(s) 1302 can be configured to communicate with one or more other computing devices, which can be located in the front-of-house (e.g., POS device(s)) and/or back-of-house (e.g., kitchen display system(s) (KDS)). In at least one example, the seller platform 1310 can provide order management services and/or fulfillment services to enable restaurants (or other merchant types) to manage open tickets, split tickets, and so on and/or manage fulfillment services.

In some examples, the seller platform 1310 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the seller platform 1310 can leverage other merchants and/or sales channels that are part of the seller platform 1310 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the seller platform 1310 can enable conversational commerce via conversational commerce services, which can use one or more machine learning mechanisms to analyze messages exchanged between two or more users 1316, voice inputs into a virtual assistant or the like, to determine intents of user(s) 1316. In some examples, the seller platform 1310 can utilize determined intents to automate customer service, offer promotions, provide recommendations, or otherwise interact with customers in real-time. In at least one example, the seller platform 1310 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1316 may be new to the seller platform 1310 such that the user 1316 that has not registered (e.g., subscribed to receive access to one or more services offered by the seller platform 1310) with the seller platform 1310. The seller platform 1310 can offer onboarding services for registering a potential user 1316 with the seller platform 1310. In some examples, onboarding can involve presenting various questions, prompts, and the like to a potential user 1316 to obtain information that can be used to generate a profile for the potential user 1316. In at least one example, the seller platform 1310 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the seller platform 1310 can be transitioned to more permissive (e.g., less limited) or longer-term access to such services.

The seller platform 1310 can be associated with IDV services, which can be used by the seller platform 1310 for compliance purposes and/or can be offered as a service, for instance to third-party service providers (e.g., associated with the server(s) 1308). That is, the seller platform 1310 can offer IDV services to verify the identity of users 1316 seeking to use or using their services. Identity verification may involve requesting a customer (or potential customer) to provide information that is used by compliance departments to prove that the information is associated with an identity of a real person or entity (e.g., an artist). In at least one example, the seller platform 1310 can perform services for determining whether identifying information provided by a user 1316 accurately identifies the customer (or potential customer).

Techniques described herein can be configured to operate in both real-time/online and offline modes. “Online” modes refer to modes when devices are capable of communicating with the seller platform 1310 while offline mode refers to modes when devices are unable to communicate with the server(s) 1308 due to network connectivity issue, for example. In such examples, devices may operate in “offline” mode where at least some payment data is stored (e.g., on the seller device(s) 1306(A)) and/or the server(s) 1302 until connectivity is restored and the payment data can be transmitted to the server(s) 1302 and/or the server(s) 1308 for processing.

In at least one example, the seller platform 1310 can be associated with a hub, such as an order hub, an inventory hub, a fulfillment hub and so on, which can enable integration with one or more additional service providers (e.g., associated with the additional server(s) 1308). In some examples, such additional service providers can offer additional or alternative services and the service provider can provide an interface or other computer-readable instructions to integrate functionality of the service provider into the one or more additional service providers.

Turning now to the P2P functionality provided by the environment 1300, the P2P platform 1312 can provide a peer-to-peer payment service that enables peer-to-peer payments between two or more of the users 1316. Two or more of the users 1316 may be considered “peers” in a peer-to-peer interaction, such as a payment. In at least one example, the P2P platform 1312 can communicate with instances of a payment application 1326 (or other access point) installed on end user devices 1306 configured for operation by the users 1316. In an example, an instance of the payment application 1326 executing on a first user device 1306(B) operated by a payor (e.g., one of the users 1316) can send a request to the P2P platform 1312 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1316) via a peer-to-peer payment. In some examples, assets associated with an account of the payor are transferred to an account of the payee. In some examples, assets can be held at least temporarily in an account of the P2P platform 1312 prior to transferring the assets to the account of the payee.

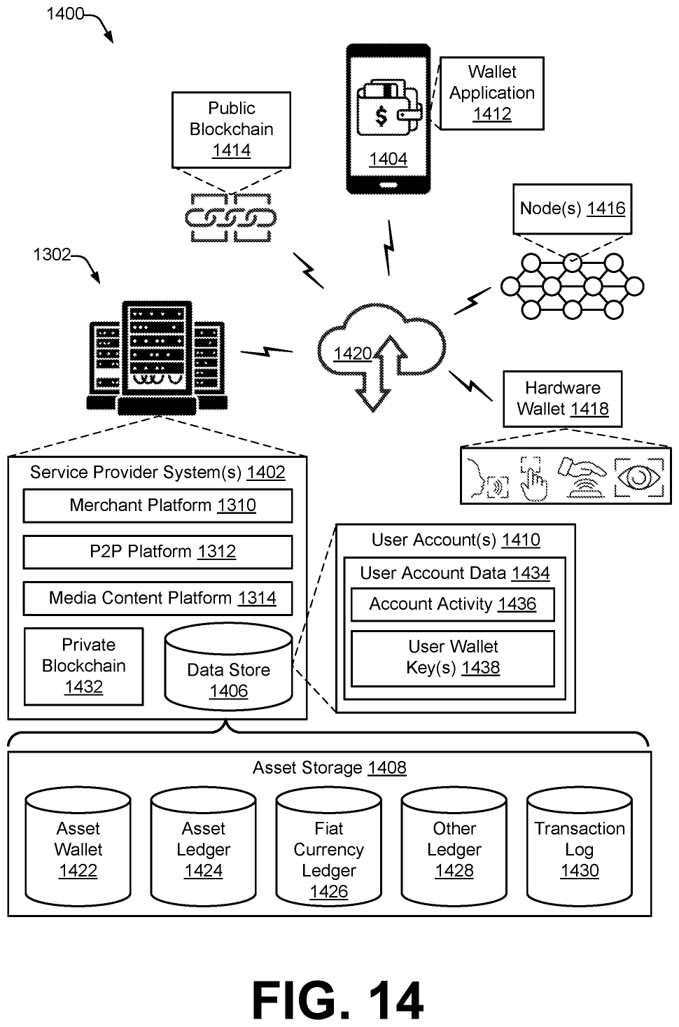

In some examples, the P2P platform 1312 can utilize a ledger system to track transfers of assets between users 1316. FIG. 14, below, provides additional details associated with such a ledger system. The ledger system can enable users 1316 to own fractional shares of assets that are not conventionally available. For instance, a user can own a fraction of a Bitcoin, an NFT, or a stock. Additional details are described herein.

In at least one example, the P2P platform 1312 can facilitate transfers and can send notifications related thereto to instances of the payment application 1326 executing on user device(s) of payee(s). As an example, the P2P platform 1312 can transfer assets from an account of a first user to an account of a second user and can send a notification to the user device 1306(B) of the second user for presentation via a user interface. The notification can indicate that a transfer is in process, a transfer is complete, or the like. In some examples, the P2P platform 1312 can send additional or alternative information to the instances of the payment application 1326 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1312 funds the request to payee on behalf of the payor, to speed up the transfer process and compensate for lags that may be attributed to the payor's financial network.

In some examples, the P2P platform 1312 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1302 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist, or band names, and/or the like can be used to trigger and/or identify users of a peer-to-peer payment process.

In some examples, the peer-to-peer payment process can be initiated through instances of the payment application 1326 executing on the end user devices 1306. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1312 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 13 or a third-party service provider associated with the server(s) 1308. In examples where the content provider is a third-party service provider, the server(s) 1308 can be accessible via one or more APIs 1318 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1312 (e.g., the P2P platform 1312 offers a chat or messaging service that is within the payment application or accessible via the payment application). In some examples, the messaging application can be external to the P2P platform 1312. (e.g., the messaging application is hosted by a third-party service provider associated with the server(s) 1308, which can be accessible via one or more of the APIs 1318 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1312 can enable users 1316 to perform banking transactions via instances of the payment application 1326. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 1312 can enable users to allocate funds between different accounts, sub-accounts, or balances (e.g., spending, saving, different assets, different currencies), etc. Further, users 1316 can configure bill pay, recurring payments, and/or the like using assets associated with their accounts. In some examples, the P2P platform 1312, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1312 enables users to buy and/or sell assets via asset networks such as cryptocurrency networks, securities networks, and/or the like. In some examples, acquisition of such assets can be in whole or fractional shares. The ledger system described below with reference to FIG. 14 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1312 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1312 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1312 can automatically apply the amount of funds associated with the gift card to the transaction.

In some examples, users can configure their account such that when they use their payment instruments, the P2P platform 1312 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1312 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1312 can present activity data via an activity user interface of the payment application. In some examples, activity can be presented by merchant, date, time, amount, or the like. In some examples, interactions between entities can be represented in conversational communications such that an interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1312 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1312.

In some examples, components of the environment 1300 may be integrated to enable payments at the point-of-sale using assets associated with user accounts of the P2P platform 1312. As illustrated in the environment 1300, the components can communicate with one another via the network 1304, where one or more APIs 1318 or other functional components can be used to facilitate such communication.

In at least one example, an integration can enable a customer to participate in a transaction via their own computing device (e.g., user device 1306(B)) instead of interacting with a merchant device of a merchant, such as the seller device 1306(A). In such an example, the POS application 1320, associated with a payment processing platform and executable by the seller device 1306(A) of the merchant, can present a Quick Response (QR) code, or other code that can be used to identify a transaction (e.g., a transaction code), in association with a transaction between the customer and the merchant. The QR code, or other transaction code, can be provided to the POS application 1320 via an API 1318 associated with the peer-to-peer payment platform. In an example, the customer can utilize their own computing device, such as the user device 1306(B), to capture the QR code, or the other transaction code, and to provide an indication of the captured QR code, or other transaction code, to server(s) 1302.

Based at least in part on the integration of the peer-to-peer payment platform and the payment processing platform (e.g., via the API 1318), the server(s) 1302 of the seller platform 1310 can exchange communications with a payment application 1326 associated with the P2P platform 1312 and/or the POS application 1320 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1312 and seller platform 1310 (which can be a first- or third-party integration) such that a QR code, or other transaction code, specific to the transaction can be used for providing transaction details, location details, customer details, or the like to a computing device of the customer, such as the user device 1306(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1306(B), can be specially configured as a buyer-facing device that can enable the customer to view cart building in near-real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, which can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1320 and the payment application 1326, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1306(B), can be specially configured as a buyer-facing device having functionality similar to the functionality described above in the brick-and-mortar example.

In some examples, based at least in part on capturing the QR code, or other transaction code, the seller platform 1310 can provide transaction data to the P2P platform 1312 for presentation via the payment application 1326 on the computing device of the customer, such as the user device 1306B(B), to enable the customer to complete the transaction via their own computing device. In some examples, in response to receiving an indication that the QR code, or other transaction code, has been captured or otherwise interacted with via the customer computing device, the P2P platform 1312 can determine that the customer authorizes payment of the transaction using funds associated with a stored balance of the customer that is managed and/or maintained by the P2P platform 1312. Such authorization can be implicit such that the interaction with the transaction code can imply authorization of the customer. Alternatively, or additionally, the P2P platform 1312 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly, or explicitly) of the customer, the P2P platform 1312 can transfer funds from the stored balance of the customer to the seller platform 1310. In at least one example, the seller platform 1310 can deposit the funds, or a portion thereof, into a stored balance of the merchant that is managed and/or maintained by the seller platform 1310. In such an example, the seller platform 1310 can be a “peer” to the customer in a peer-to-peer transaction.

In some examples, techniques described herein can enable the customer to interact with the transaction after payment for the transaction has been settled. For example, in at least one example, the seller platform 1310 can cause a total amount of a transaction to be presented via a user interface associated with the payment application 1326 such that the customer can provide gratuity, feedback, loyalty information, or the like, via an interaction with the user interface. In another example, the seller platform 1310 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1312, if the customer inputs a tip and/or an event affecting the total amount of the transaction is triggered, the P2P platform 1312 can transfer additional funds, associated with the tip or event, to the seller platform 1310. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1326 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1312 as described herein (e.g., a debit card linked to a stored balance of a customer) such that when the payment instrument is caused to interact with a payment reader, the seller platform 1310 can exchange communications with the P2P platform 1312 to authorize payment for a transaction and/or provision associated transaction data to a computing device of the customer associated with the transaction.

Turning now to media content functionality provided by the environment 1300, the media content service provider system 1314 can provide digital media to a content consumption device 1306(D) where playback may occur using “streaming.” In examples, “streaming” media content involves encoding the media content and transmitting the encoded media content over the network 1304 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content service provider system 1314 can provide a digital media streaming service (e.g., subscription-based, non-subscription-based) that enables a content consumption device 1306(D) to stream and/or download digital media content via a listener application 1328 installed on the content consumption device 1306(D). For instance, the media content service provider system 1314 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1306(D), the listener application 1328 may verify access rights to the digital media content items at time intervals, for instance intermittently (e.g., when the content consumption device 1306(D) has a network connection with the media content service provider system 1314 via the network(s) 1304), and/or at regular intervals (e.g., daily, weekly, monthly, etc.). In examples, access rights to the digital media content items may be provided when a subscription to the media content service provider system 1314 is active, while access rights to the digital media content items may be withheld when the subscription to the media content service provider system 1314 is terminated. Enabling storage on the end user devices 1306 and subsequent access to digital media content items via the listener application 1328 provides the users 1316 with the ability to access the digital media content items “offline” such as when a connection to the media content service provider system 1314 via the network(s) 1304 is unavailable or unreliable.

In some examples, the media content service provider system 1314 may additionally or alternatively provide an artist management service that enables the users 1316 to manage aspects of artist business via an artist application 1330 installed on the artist device 1306(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1316 can have graduated access to the services, which can be based on a user type (e.g., artist, group member, personal engine, business engine, attorney, agent, etc.), risk tolerance, artist verification status, listener and/or viewer analytics (e.g., number of streams in a month), and so on. In some cases, multiple users 1316 may have access to a single user account via respective end user devices 1306, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1330 and the listener application 1328 may be distinct applications having differing user experiences and verification processes for access, such as illustrated in the environment 1300. For instance, the media content service provider system 1314 may request additional verification, such as a link to an artist website, a sample of an artist's work, a verified credential supplied by a third-party, etc. to grant access to the artist application 1330 in addition to information requested to access the listener application 1328. Further, the artist application 1330 may provide the artist management services described herein, without the subscription-based digital media streaming services described herein, and vice versa. However, examples are also considered in which functionality provided by the artist application 1330 and the listener application 1328 partially or fully overlap, and/or where verification processes for access are substantially similar.

In at least some examples, the media content service provider system 1314 enables interaction between the users 1316 utilizing the listener application 1328 installed on the content consumption devices 1306(D), and the users 1316 utilizing the artist application 1330 installed on the artist devices 1306(E). For example, the media content service provider system 1314 may provide interconnectivity between the subscription-based digital media streaming service and the artist management service. Functionality provided by the media content service provider system 1314 in such instances may include a communication channel between one or more of the users 1316 (e.g., a listener, fan, music supervisor, publisher, etc.) utilizing the listener application 1328 and another user (e.g., an artist) of the users 1316 utilizing the artist application 1330. The communication channel may include, for instance, a messaging platform (also referred to as a “messaging application” herein), a live streaming platform, a videoconferencing or teleconferencing platform, and/or a combination of these.

Additionally, in some cases, the media content service provider system 1314 may facilitate a resource transfer between the listener application 1328 and the artist application 1330. In an example, the media content service provider system 1314 may direct a resource, such as a portion of a subscription fee paid by one of the users 1316 designated as a listener, to one or more of the users 1316 designated as artists based on a number of instances that the listening user consumed (e.g., streamed, downloaded, etc.) content created by respective ones of the artist users. Alternatively, or additionally, the media content service provider system 1314 may direct a resource, such as funds, from an account associated with a listening user to an account associated with an artist user (or vice versa), in accordance with transfers between accounts as described herein. The media content service provider system 1314 may facilitate resource transfers in examples such as merchandise purchases, event ticket purchases, “tipping” an artist, payments for royalties or other fees, and so forth.

In some examples, the media content service provider system 1314 enables interaction between individual ones of the users 1316 with one another via the listener application 1328 installed on the content consumption device 1306(D) and other of the content consumption devices 1306(D) via a communication channel as described above. In an example, the listener application 1328 may provide functionality via a communication channel for a user to stream an individual digital media item, a playlist, or the like to an audience comprising other ones of the content consumption devices 1306(D). Alternatively, or additionally, the communication channel may facilitate sharing of individual digital media items, playlists, user and/or artist profiles, and the like between the users 1316 via messages, uniform resource locators (URLs), quick response (QR) codes, and so forth.

In some cases, the media content service provider system 1314 enables interaction between individual ones of the users 1316 with one another via the artist application 1330 installed on the artist device 1306(E) and other of the artist devices 1306 via a communication channel as described above. In some instances, the media content service provider system 1314 may provide recommendations for a particular user indicating which of the other users 1316 to communicate with. Such a recommendation may be based on a similarity (or dissimilarity) of content created by two or more of the users 1316, an overlap (or lack thereof) of audience members of the users 1316, a geographic location of the users 1316, a coinciding event location of the users 1316, and so forth. In some examples, a user may input parameters for a desired connection via the artist application 1330, and the media content service provider system 1314 may filter which of the users 1316 to surface for recommendations to the user based on the input parameters. Alternatively, or additionally, the media content service provider system 1314 may implement one or more machine learning models to filter which of the users 1316 to surface for recommendations to the user. The recommendations provided by the media content service provider system 1314 may be data driven and thus increase relevance of communications presented to the users 1316 and reduce unsolicited communications that may be received by the users 1316.

The media content service provider system 1314 may interact with the server(s) 1308 associated with the third-party service providers to, for instance, ingest digital media items, report digital media consumption data, pay royalties, and the like. In some examples, the server(s) 1308 may be accessible by the media content service provider system 1314 via one or more APIs 1318 or other integrations. In some cases, the third-party service provider may be a digital media content provider (e.g., a record label, a performance rights organization (PRO), an independent artist, etc.). In such cases, the media content service provider system 1314 may receive digital media content items from the server(s) 1308, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively, or additionally, the metadata may indicate information such as release date, track title, track duration, clean or explicit version, jurisdiction information, and the like. The media content service provider system 1314 may use the metadata to associate the digital media content item as being created by a particular user, to provide search results to the users 1316, to generate playlists, and so forth. Further, the media content service provider system 1314 may provide payments (e.g., royalties) to the third-party service provider based on a number of streams and/or downloads of individual digital media content items by the users via the listener application 1328.

Techniques described herein are directed to services provided via a distributed system of end user devices 1306 that are in communication with server(s) 1302 of the service provider. That is, techniques described herein are directed to a specific implementation—or a practical application—of utilizing a distributed system of end user devices 1306 that are in communication with server(s) 1302 of the seller platform 1310, the P2P platform 1312, and/or the media content service provider system 1314 to perform a variety of services, as described above. The unconventional configuration of the distributed system described herein enables the server(s) 1302 that are remotely-located from end-users (e.g., users 1316) to intelligently offer services based on aggregated data associated with the end-users, such as the users 1316 (e.g., data associated with multiple, different merchants and/or multiple, different buyers; data associated with multiple different listeners and/or multiple different artists, etc.), in some examples, in near-real-time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the seller platform 1310, the P2P platform 1312, and/or the media content service provider system 1314, and those outside of the control of these service providers, to track the standing (payables, receivables, payroll, invoices, appointments, capital, balances, collaborations, etc.) of the users 1316. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, AI, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1316 and end user devices 1306. Furthermore, such features are changed dynamically based on the profiles of the users involved interacting with the GUIs. As such, techniques described herein are directed to improvements to computing systems.

The seller platform 1310, the P2P platform 1312, and/or the media content service provider system 1314 are capable of providing additional or alternative services, and the services described above are offered as a sampling of services. In at least one example, the seller platform 1310, the P2P platform 1312, and/or the media content service provider system 1314 can exchange data with the server(s) 1308 associated with third-party service providers. Such third-party service providers can provide information that enables the seller platform 1310, the P2P platform 1312, and/or the media content service provider system 1314 to provide services, such as those described above. In additional or alternative examples, such third-party service providers can access services of the seller platform 1310, the P2P platform 1312, and/or the media content service provider system 1314. That is, in some examples, the third-party service providers can be subscribers, or otherwise access, services of the seller platform 1310, the P2P platform 1312, and/or the media content service provider system 1314.

FIG. 14 is a non-limiting example illustrating an environment in which resource allocation based on media content item engagement techniques described herein are performed in accordance with one or more implementations. In some examples, FIG. 14 illustrates an example environment 1400 including a service provider system 1402 which may be associated with the server(s) 1302 of FIG. 13. The environment 1400 may also include a user device 1404, which may correspond to any of the end user devices 1306 described in relation to FIG. 13. In examples, the service provider system 1402 may include one or a combination of the seller platform 1310, the P2P platform 1312, or the media content service provider system 1314, as well as one or more data store(s) 1406 that can store assets in an asset storage 1408, as well as data in user account(s) 1410. In some examples, the environment 1400 may also include a public blockchain 1414, one or more nodes 1416, and/or a hardware wallet 1418. The service provider system 1402, the user device 1404, public blockchain 1414, the node(s) 1416, and the hardware wallet 1418 may be connected and able to communicate via one or more networks 1420, which may have the same or similar functionality described in relation to the network 1304 of FIG. 13.

In some examples, user account(s) 1410 can include merchant account(s), customer account(s), media content subscriber account(s), artist account(s), and so forth. In at least one example, the asset storage 1408 can be used to record whether individual assets are registered to a user account 1410. For example, the asset storage 1408 can include asset wallet(s) 1422 for storing records of assets owned by the service provider system 1402, such as cryptocurrency, securities, NFTs, or the like, and communicating with one or more asset networks, such as cryptocurrency networks. NFT networks, securities networks, or the like. In some examples, the asset network can be a first-party network or a third-party network, such as a cryptocurrency exchange or the stock market. In examples where the asset network is a third-party network, the server(s) 1308 of FIG. 13 can be associated therewith.

The asset wallet 1422 can be associated with one or more addresses and can vary addresses used to acquire assets (e.g., from the asset network(s)) so that its holdings are represented under a variety of addresses on the asset network. In examples where the service provider system 1402 has holdings of cryptocurrency (e.g., in the asset wallet 1422), a user can acquire cryptocurrency directly from the service provider system 1402. In some examples, the service provider system 1402 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 1402 can provide the same or similar functionality for securities or other assets.

The asset storage 1408 may contain ledgers that store records of assignments of assets to users 1316. Specifically, the asset storage 1408 may include asset ledger 1424, fiat currency ledger 1426, and/or other ledger(s) 1428, which can be used to record transfers of assets between users 1316 and/or one or more third-parties (e.g., merchant network(s), payment card network(s). ACH network(s), equities network(s), the asset network, securities networks, etc.). In doing so, the asset storage 1408 can maintain a running balance of assets managed by the service provider system 1402. The ledger(s) of the asset storage 1408 can further indicate some of the running balance for individual ledger(s) stored in the asset storage 1408 are assigned or registered to one or more user account(s) 1410.

In at least one example, the asset storage 1408 can include transaction logs 1430, which can include, as transaction data, records of past transactions involving the service provider system 1402 and/or the user account 1410. In some examples, the data store(s) 1406 can store a private blockchain 1432. A private blockchain 1432 can function to record sender addresses, recipient addresses, public keys, values of cryptocurrency transferred, and/or can be used to verify ownership of cryptocurrency tokens to be transferred. In some examples, the service provider system 1402 can record transactions involving cryptocurrency until the number of transactions has exceeded a determined limit (e.g., number of transactions, storage space allocation, etc.). Based at least in part on determining that the limit has been reached, the service provider system 1402 can publish the transactions in the private blockchain 1432 to the public blockchain 1414 (e.g., associated with the asset network), where miners can verify the transactions and record the transactions to blocks on the public blockchain 1414. In at least one example, the service provider system 1402 can participate as miner(s) at least for transactions to which the respective platform is a party to, to be posted to the public blockchain 1414.

In some cases, the data store(s) 1406 can store and/or manage multiple user accounts, an example of which is described in relation to the user account 1410. In at least one example, the user account 1410 can include user account data 1434, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1434 can include account activity 1436 and user wallet key(s) 1438. In some examples, the user wallet key(s) 1438 can include a public-private key-pair and a respective address associated with the asset network or other asset networks. In some examples, the user wallet key(s) 1438 may include one or more key pairs, which can be unique to the asset network or other asset networks.

In addition to the user account data 1434, the user account 1410 can include ledger(s) for account(s) managed by the service provider system 1402, for the user. For example, the user account 1410 may include an asset ledger 1424, a fiat currency ledger 1426, and/or one or more other ledgers 1428. The ledger(s) can indicate that a corresponding user utilizes the service provider system 1402 to manage corresponding accounts (e.g., a cryptocurrency account, a securities account, a flat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 1402.

In some examples, the asset ledger 1424 can store a balance for one or more cryptocurrencies (e.g., Bitcoin, Ethereum, Litecoin, etc.) registered to the user account 1410. In at least one example, the asset ledger 1424 can further record transactions of cryptocurrency assets associated with the user account 1410. For example, the user account 1410 can receive cryptocurrency from the asset network using the user wallet key(s) 1438. In some examples, the user wallet key(s) 1438 may be generated for the user upon request. User wallet key(s) 1438 can be requested by the user in order to send, exchange, or otherwise control the balance of cryptocurrency held by the service provider system 1402 (e.g., in the asset wallet 1422) and registered to the user. In some examples, the user wallet key(s) 1438 may not be generated until a user account requires such. This on-the-fly wallet key generation provides enhanced security features for users, reducing the number of access points to a user account's balance and, therefore, limiting exposure to external threats.

An account ledger can reflect a positive balance when funds are added to the corresponding account. An account can be funded by transferring currency in the form associated with the account from an external account (e.g., transferring a value of cryptocurrency to the service provider system 1402 and the value is credited as a balance in asset ledger 1424), by purchasing currency in the form associated with the account using currency in a different form (e.g., buying a value of cryptocurrency from the service provider system 1402 using a value of fiat currency reflected in fiat currency ledger 1426, and crediting the value of cryptocurrency in asset ledger 1424), or by conducting a transaction with another user (customer or merchant) of the service provider system 1402 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 1402 (i.e., an external account). Such a transaction can request that the user to transfer an amount of the cryptocurrency in a message signed by user's private key to an address provided by the service provider system 1402. In at least one example, the transaction can be sent to miners to bundle the transaction into a block of transactions and to verify the authenticity of the transactions in the block. Once a miner has verified the block, the block is written to the public blockchain 1414 where the service provider system 1402 can then verify that the transaction has been confirmed and can credit the user's asset ledger 1424 with the transferred amount. When an account is funded by transferring cryptocurrency from a third-party cryptocurrency wallet, an update can be made to the public blockchain 1414. In some cases, this update of the public blockchain 1414 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 1402. As described above, in some examples, the service provider system 1402 can acquire cryptocurrency from a third-party source. In examples where the service provider system 1402 has its own cryptocurrency assets, cryptocurrency transferred in a transaction (e.g., data with address provided for receipt of transaction and a balance of cryptocurrency transferred in the transaction) can be stored in an asset wallet 1422 associated with the service provider system 1402. In at least one example, the service provider system 1402 can credit the asset ledger 1424 of the user. Additionally, while the service provider system 1402 recognizes that the user retains the value of the transferred cryptocurrency through crediting the asset ledger 1424, an inspection of the blockchain will show the cryptocurrency as having been transferred to the service provider system 1402. In some examples, the asset wallet 1422 can be associated with many different addresses. In such examples, an inspection of the blockchain may not necessarily associate all cryptocurrency stored in asset wallet 1422 as belonging to the same entity. The presence of a private ledger used for real-time transactions and maintained by the service provider system 1402, combined with updates to the public ledger at other times, allows for extremely fast transactions using cryptocurrency to be achieved. In some examples, the “private ledger” can refer to the asset ledger 1424, which in some examples, can utilize the private blockchain 1432, as described herein. The “public ledger” can correspond to the public blockchain 1414 associated with the asset network.

In at least one example, an asset ledger 1424, fiat currency ledger 1426, or the like associated with the user account 1410 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1424. In some examples, a user can receive fiat currency or another currency in the form of payment for a transaction with another user. In at least one example, at least a portion of such funds can be converted into cryptocurrency by the service provider system 1402 and used to fund the asset ledger 1424 of the user.

In examples, a user can also have an account in U.S. dollars, which can be tracked, for example, via the fiat currency ledger 1426. Such an account can be funded by transferring money from a bank account at a third-party bank to an account maintained by the service provider system 1402 as is conventionally known. In some examples, a user can receive fiat currency in the form of payment for a transaction with another user. In such examples, at least a portion of such funds can be used to fund the fiat currency ledger 1426.

In some examples, a user can have one or more internal payment cards registered with the service provider system 1402. Internal payment cards can be linked to one or more of the accounts associated with the user account 1410. In some embodiments, options with respect to internal payment cards can be adjusted and managed using an application (e.g., the payment application 1326, a wallet application 1412, etc.).

In at least one example, the user account 1410 can be associated with the asset wallet accessible via a wallet application 1412 of the user device 1404, or a stored balance for use in payment transactions, peer-to-peer transactions, payroll payments, etc. In at least one example, the asset wallet 1422 can store data indicating an address provided for receipt of a cryptocurrency transaction. In at least one example, the balance of the asset wallet 1422 can be based at least in part on a balance of the asset ledger 1424. In at least one example, funds availed via the asset wallet 1422 can be stored in the asset wallet 1422. Funds availed via the asset wallet 1422 can be tracked via the asset ledger 1424. The asset wallet 1422, however, can be associated with additional cryptocurrency funds.

In at least one example, when the service provider system 1402 includes a private blockchain 1432 for recording and validating cryptocurrency transactions, the asset wallet 1422 can be used instead of, or in addition to, the asset ledger 1424. For example, a merchant can provide the address of the asset wallet 1422 for receiving payments. In an example where a customer is paying in cryptocurrency and the customer has their own cryptocurrency wallet account associated with the service provider system 1402, the customer can send a message signed by its private key including its wallet address (i.e., of the customer) and identifying the cryptocurrency and value to be transferred to the merchant's asset wallet 1422. The service provider system 1402 can complete the transaction by reducing the cryptocurrency balance in the customer's cryptocurrency wallet and increasing the cryptocurrency balance in the merchant's asset wallet 1422. In addition to recording the transaction in the respective cryptocurrency wallets, the transaction can be recorded in the private blockchain 1432, and the transaction can be confirmed. A user can perform a similar transaction with cryptocurrency in a peer-to-peer transaction as described above.

While the asset ledger 1424 and/or asset wallet 1422 are described above with reference to cryptocurrency, the asset ledger 1424 and/or asset wallet 1422 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 1402 is an aspect of the technology disclosed that enables technical advantages of increased processing speed and improved security.

The description of the environment 1400 above generally relates to a centralized service provider that at least partially facilitates storing and managing assets in the data store 1406. However, the environment 1400 may also facilitate decentralized storage and management of assets alternatively or in addition to centralized storage and management as described above. For instance, the environment 1400 may include a decentralized platform implemented using a plurality of nodes (e.g., web nodes), an example of which is illustrated as node 1416. The node 1416 is representative of a computer or other device tasked with validating transactions and/or maintaining a copy of a blockchain ledger, such as a ledger associated with the public blockchain 1414. The decentralized platform may be implemented via the environment 1400 through use of decentralized identifiers and verifiable credentials that are stored and managed by user devices 1404. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 1402). The decentralized identity referenced by a decentralized identifier gives an entity control over what data can be accessed, stored, modified, and so forth by other entities, such as the service provider system 1402.

The node 1416, as representative of one of a plurality of decentralized nodes (e.g., decentralized web nodes), supports data storage and relays that allows entities, service provider systems, individuals, organizations and so forth to send, store, and receive encrypted or public messages and data. The node 1416 is universally addressable and is “crawlable” using data addressing in relation to the decentralized identifiers. The node 1416 is also configured to support decentralized replication of data across the nodes that is consistent across multiple nodes over time through continued data communication between the nodes in the decentralized platform. The node 1416 is configurable to support secure encryption through use of a cryptographic key associated with an individual's decentralized identifier and support semantic discovery to discover different forms of published data.

Verifiable credentials are an open standard for digital credentials and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 1404 may be an issuer, a holder, and/or a verifier, as can the service provider system 1402.

In some examples, the user device 1404 may implement a wallet application 1412 configured to manage decentralized identifiers and/or verifiable credentials. For instance, the wallet application 1412 may provide a user interface for implementation of access controls to various data associated with the decentralized identifier by the service provider system 1402, to other user devices, and so forth. Additionally, the wallet application 1412 may be configured to provide functionality for resource transfers (e.g., cryptocurrency, fiat currency, etc.) with the service provider system 1402, other user devices, and the like, based on techniques described herein.

In some examples, the hardware wallet 1418 may store cryptocurrency assets in combination with the wallet application 1412 and the service provider system 1402. For instance, the hardware wallet 1418, the wallet application 1412, and the service provider system 1402 may store a respective, different private key, where a transaction with the cryptocurrency assets is signed by at least two of the three private keys. The user interface provided by the wallet application 1412 may allow a user to request a transaction. The wallet application 1412 may then sign the transaction with the private key of the wallet application 1412, have either the hardware wallet 1418 or the service provider system 1402 use a second of the three private keys to sign the transaction, and then provide the transaction with two signatures to the public blockchain 1414 for processing.

FIG. 15 is a non-limiting example illustrating an environment in which resource allocation based on media content item engagement techniques described herein are performed in accordance with one or more implementations. The system 1500 includes a user device 1502, that communicates with server computing device(s) (e.g., server(s) 1504) via network(s) 1506 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1502 is illustrated, in additional or alternate examples, the system 1500 can have multiple user devices, as described above with reference to FIG. 13.

In the context of the previously described figures, for example, the server(s) 1504 and/or the user device 1502 may be used to implement the engagement platform 126 and/or various portions of the one or more media content service provider systems 102.

In at least one example, the user device 1502 can be any suitable type of computing device, e.g., portable, semi-portable, semi-stationary, or stationary. Some examples of the user device 1502 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 1502 can be any computing device capable of sending communications and performing the functions according to the techniques described herein. The user device 1502 can include devices, e.g., payment card readers, or components capable of accepting payments, as described below. The user device 1502 may be representative of, and provide functionality for, the user devices 1306 described in relation to FIG. 13.

In the illustrated example, the user device 1502 includes one or more processors 1508, one or more computer-readable media 1510, one or more communication interface(s) 1512, one or more input/output (I/O) devices 1514, a display 1516, and sensor(s) 1518. The user device 1502 is also configurable to include one or more encoders and one or more decoders.

In at least one example, a processor 1508 can itself comprise one or more processors or processing cores. For example, the processor(s) 1508 can be implemented as one or more microprocessors, microcomputers, microcontrollers, digital signal processors, central processing units, state machines, logic circuitries, and/or any devices that manipulate signals based on operational instructions. In some examples, the processor(s) 1508 can be one or more hardware processors and/or logic circuits of any suitable type specifically programmed or configured to execute the algorithms and processes described herein. The processor(s) 1508 can be configured to fetch and execute computer-readable processor-executable instructions stored in the computer-readable media 1510.

Depending on the configuration of the user device 1502, the computer-readable media 1510 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1510 can include, but is not limited to, RAM, ROM, EEPROM, flash memory, solid-state storage, magnetic disk storage, optical storage, and/or other computer-readable media technology. Further, in some examples, the user device 1502 can access external storage, such as RAID storage systems, storage arrays, network attached storage, storage area networks, cloud storage, or any other medium that can be used to store information and that can be accessed by the processor(s) 1508 directly or through another computing device or network. Accordingly, the computer-readable media 1510 can be computer storage media able to store instructions, components or components that can be executed by the processor(s) 1508. Further, when mentioned, non-transitory computer-readable media exclude media such as energy, carrier signals, electromagnetic waves, and signals per se.

The computer-readable media 1510 can be used to store and maintain any number of functional components that are executable by the processor(s) 1508. In some implementations, these functional components comprise instructions or programs that are executable by the processor(s) 1508 and that, when executed, implement operational logic for performing the actions and services attributed above to the user device 1502. Functional components stored in the computer-readable media 1510 can include a user interface 1520 to enable users to interact with the user device 1502, and thus the server(s) 1504 and/or other networked devices, such as the user interfaces as described with reference to FIGS. 4 through 9. In at least one example, a user can interact with the user interface via touch input, spoken input, gesture, or any other type of input. The word “input” is also used to describe “contextual” input that may not be directly provided by the user via the user interface 1520. For example, user's interactions with the user interface 1520 are analyzed using, e.g., natural language processing techniques, user movement tracking techniques, eye tracking techniques, etc. to determine context or intent of the user, which may be treated in a manner similar to “direct” user input.

Depending on the type of the user device 1502, the computer-readable media 1510 can also optionally include other functional components and data, such as other components and data 1522, which can include programs, drivers, etc., and the data used or generated by the functional components. In addition, the computer-readable media 1510 can also store data, data structures and the like, that are used by the functional components. Further, the user device 1502 can include many other logical, programmatic, and physical components, of which those described are merely examples that are related to the discussion herein.

In at least one example, the computer-readable media 1510 can include additional functional components, such as an operating system 1524 for controlling and managing various functions of the user device 1502 and for enabling user interactions.

The communication interface(s) 1512 can include one or more interfaces and hardware components for enabling communication with various other devices, such as over the network(s) 1506 or directly. For example, communication interface(s) 1512 can enable communication through one or more network(s) 1506, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1506 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1502 can further include one or more input/output (I/O) devices 1514. The U/O devices 1514 can include speakers, a microphone, a camera, and various user controls (e.g., buttons, a joystick, a keyboard, a keypad, etc.), a haptic output device, and so forth. The I/O devices 1514 can also include attachments that leverage the accessories (audio-jack, USB-C, Bluetooth, etc.) to connect with the user device 1502.

In at least one example, user device 1502 can include a display 1516. Depending on the type of computing device(s) used as the user device 1502, the display 1516 can employ any suitable display technology. For example, the display 1516 can be a liquid crystal display, a plasma display, a light emitting diode display, an OLED (organic light-emitting diode) display, an electronic paper display, or any other suitable type of display able to present digital content thereon. In at least one example, the display 1516 can be an augmented reality display, a virtual reality display, or any other display able to present and/or project digital content. In some examples, the display 1516 can have a touch sensor associated with the display 1516 to provide a touchscreen display configured to receive touch inputs for enabling interaction with a graphic interface presented on the display 1516. Accordingly, implementations herein are not limited to any particular display technology. In some examples, the user device 1502 may not include the display 1516, and information can be presented by other means, such as aurally, haptically, etc.

In addition, the user device 1502 can include sensor(s) 1518. The sensor(s) 1518 can include a global positioning system (“GPS”) device able to indicate location information. Further, the sensor(s) 1518 can include, but are not limited to, an accelerometer, gyroscope, compass, proximity sensor, camera, microphone, and/or a switch.

In some examples, the GPS device can be used to identify a location of a user. In at least one example, the location of the user can be used by the seller platform 1310, the P2P platform 1312, and/or the media content service provider system 1314, described above, to provide one or more services. That is, in some examples, the service provider can implement geofencing to provide particular services to users by the seller platform 1310, the P2P platform 1312, and/or the media content service provider system 1314.

In examples, the user device 1502 includes a codec system, which may comprise an encoder and/or a decoder. The encoder is configured to encode a data stream or signal from an analog signal (e.g., an analog audio signal, an analog video signal, etc.) to a digital signal for transmission or storage. The decoder is configured to convert the digital signal back to an analog signal, such as for playback or editing. In some cases, the encoder may be configured to encode the data stream or analog signal in an encrypted format, and the decoder may accordingly be configured to decrypt the digital signal as part of the decoding process (e.g., using a cryptographic key). Additionally, in some examples, the encoder may compress data to reduce transmission bandwidth and/or storage space for the digital signal. One example of a compression codec system is a lossless codec, in which the digital data stream is a compressed format of the original data stream but retains the information present in the original data stream. Another example of a compression codec system is a lossy codec which reduces the quality of the digital data stream but can increase the compression of the data stream relative to lossless codec systems. The codec system comprising the encoder and/or the decoder may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 1500, the server 1504 may include an encoder and/or a decoder as well.

Additionally, the user device 1502 can include various other components that are not shown, examples of which include removable storage, a power source, such as a battery and power control unit, a barcode scanner, a printer, a cash drawer, and so forth.

In addition, as described in relation to FIG. 13, the user device 1502 can include, be connectable to, or otherwise be coupled to a reader device 1526, for reading payment instruments and/or identifiers associated with payment objects. The reader device 1526 can include a read head for reading a magnetic strip of a payment card, and further can include encryption technology for encrypting the information read from the magnetic strip. Additionally or alternatively, the reader device 1526 can be an EMV payment reader, which in some examples, can be embedded in the user device 1502. Moreover, numerous other types of readers can be employed with the user device 1502 herein, depending on the type and configuration of the user device 1502.

The reader device 1526 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 1526 may include hardware implementation, such as slots, magnetic tracks, and rails with one or more sensors or electrical contacts to facilitate detection and acceptance of a payment instrument. That is, the reader device 1526 may include hardware implementations to enable the reader device 1526 to interact with a payment instrument via a swipe, a dip, or a tap to obtain payment data associated with a customer. Additionally, or optionally, the reader device 1526 may also include a biometric sensor to receive and process biometric characteristics and process them as payment instruments, given that such biometric characteristics are registered with the payment service and connected to a financial account with a bank server. The reader device 1526 may include processing unit(s), computer-readable media, a reader chip, a transaction chip, a timer, a clock, a network interface, a power supply, and so on. That is, the reader device 1526 may include any of the computing components described herein with reference to the user device 1502 to implement the functionality provided by the reader device 1526.

In examples, the reader device 1526 includes a reader chip, which may perform functionality to control the power supply, among other functionality of the reader device 1526. The power supply may include one or more power supplies such as a physical connection to AC power or a battery. Power supply may include power conversion circuitry for converting AC power and generating a plurality of DC voltages for use by components of reader device 1526. When power supply includes a battery, the battery may be charged via a physical power connection, via inductive charging, or via any other suitable method.

The reader device 1526 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1502, which can be a POS terminal, and the reader device 1526 are shown as separate devices, in additional or alternative examples, the user device 1502 and the reader device 1526 can be part of a single device, which may be a battery-operated device. In some examples, the reader device 1526 can have a display integrated therewith, which can be in addition to (or as an alternative of) the display 1516 associated with the user device 1502.

The server(s) 1504 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1504 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1504 can be located together or separately, and organized, for example, as virtual servers, server banks and/or server farms. The described functionality can be provided by the servers of a single merchant or enterprise or can be provided by the servers and/or services of multiple different customers or enterprises.

In the illustrated example, the server(s) 1504 can include one or more processors 1528, one or more computer-readable media 1530, one or more I/O devices 1532, and one or more communication interfaces 1534. A processor 1528 can be a single processing unit or a number of processing units and can include single or multiple computing units or multiple processing cores. The processor(s) 1528 can be implemented as one or more microprocessors, microcomputers, microcontrollers, digital signal processors, central processing units, state machines, logic circuitries, and/or any devices that manipulate signals based on operational instructions. For example, the processor(s) 1528 can be one or more hardware processors and/or logic circuits of any suitable type specifically programmed or configured to execute the algorithms and processes described herein. The processor(s) 1528 can be configured to fetch and execute computer-readable instructions stored in the computer-readable media 1530, which can program the processor(s) 1528 to perform the functions described herein.

The computer-readable media 1530 can include volatile and nonvolatile memory and/or removable and non-removable media implemented in any type of technology for storage of information, such as computer-readable instructions, data structures, program components, or other data. Such computer-readable media 1530 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1504, the computer-readable media 1530 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1530 can be used to store any number of functional components that are executable by the processor(s) 1528. In many implementations, these functional components comprise instructions or programs that are executable by the processors 1528 and that, when executed, specifically configure the one or more processors 1528 to perform the actions attributed above to the seller platform 1310, the P2P platform 1312, and/or the media content service provider system 1314. Functional components stored in the computer-readable media 1530 can optionally include a merchant component 1536, a training component 1538, and one or more other components and data 1540. The computer-readable media 1530 can additionally include an operating system 1542 for controlling and managing various functions of the server(s) 1504.

The merchant component 1536 can be configured to receive transaction data from POS systems, such as the POS system 1324 described above with reference to FIG. 13. The merchant component 1536 can transmit requests (e.g., authorization, capture, settlement, etc.) to payment service server computing device(s) to facilitate POS transactions between merchants and customers. The merchant component 1536 can communicate the successes or failures of the POS transactions to the POS systems.

The training component 1538 can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1502 and/or the server(s) 1504 for use at a time after the data models have been trained (e.g., at runtime).

The one or more other components and data 1540 can include functionality of which is described above. Further, the one or more other components and data 1540 can include programs, drivers, etc., and the data used or generated by the functional components. Further, the server(s) 1504 can include many other logical, programmatic, and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile, or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize an SDK to integrate third-party service provider functionality into its applications. That is, API(s) and/or SDK(s) can enable third-party developers to customize how their respective third-party applications interact with the service provider or vice versa.

The communication interface(s) 1534 can include one or more interfaces and hardware components for enabling communication with various other devices, such as over the network(s) 1506 or directly. For example, communication interface(s) 1534 can enable communication through one or more network(s) 1506, which can include, but are not limited any type of network known in the art, as described herein.

The server(s) 1504 can further be equipped with various I/O devices 1532. Such I/O devices 1532 can include a display, various user interface controls (e.g., buttons, joystick, keyboard, mouse, touch screen, biometric or sensory input devices, etc.), audio speakers, connection ports and so forth.

In at least one example, the system 1500 can include a datastore 1544 that can be configured to store data that is accessible, manageable, and updatable. In some examples, the datastore 1544 can be integrated with the user device 1502 and/or the server(s) 1504. In other examples, as shown in FIG. 15, the datastore 1544 can be located remotely from the server(s) 1504 and can be accessible to the server(s) 1504. The datastore 1544 can comprise multiple databases and/or servers connected locally and/or remotely via the network(s) 1506. In at least one example, the datastore 1544 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content service provider system(s), listening trends, etc.), fan data (number of followers on media content service provider system(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 1544 can store inventory database(s) and/or catalog database(s). As described above, an inventory can store data associated with a quantity of various items that a merchant has available to the merchant. Furthermore, a catalog can store data associated with items that a merchant has available for acquisition. The datastore 1544 can store additional or alternative types of data as described herein.

In some aspects, the techniques described herein relate to a computer-implemented method including obtaining engagement by a set of user accounts with respective media content items of a set of media content items on at least one media content service provider system, generating historical streaming data for the respective media content items based on the engagement of the set of user accounts with the respective media content items, determining an estimated streaming count of a media content item of the set of media content items over a time period based on the historical streaming data for the respective media content items, determining, based on the estimated streaming count and prior to receiving an actual streaming count, an estimated resource allocation for the artist of the media content item, where the estimated resource allocation corresponds to the time period, and facilitating an advance of funds based on the estimated resource allocation to an account associated with the artist during the time period.

In some aspects, the techniques described herein relate to a computer-implemented method, further including receiving a request to withdraw at least a portion of the advance of funds from the account, and selectively withdrawing at least the portion of the advance of funds from the account based on at least one of the historical streaming data, a confidence level for the artist, or one or more data sets, where the one or more data sets include at least one of data associated with the media content item from a media content service provider system application, data associated with the media content item from a social platform application, data associated with the artist from the social platform application, or data that indicates additional resource allocation associated with the artist.

In some aspects, the techniques described herein relate to a computer-implemented method, where selectively withdrawing at least the portion of the advance of funds includes withdrawing at least the portion of the advance of funds from the account based on at least one of the historical streaming data satisfying a streaming threshold value, the confidence level satisfying a confidence threshold value, or respective data values associated with the one or more data sets satisfying at least one threshold value.

In some aspects, the techniques described herein relate to a computer-implemented method, where selectively withdrawing at least the portion of the advance of funds includes withholding withdrawal of at least the portion of the advance of funds from the account based on at least one of the historical streaming data failing to satisfy a streaming threshold value, the confidence level failing to satisfy a confidence threshold value, or respective data values associated with the one or more data sets failing to satisfy at least one threshold value, and outputting, for display at a computing device, a message indicating the withholding of the withdrawal.

In some aspects, the techniques described herein relate to a computer-implemented method, further including determining, based on one or more data sets, a confidence interval corresponding to the estimated resource allocation, where a size of the confidence interval is based on at least one of a numerical quantity of data values in the one or more data sets or a variability of respective data in the one or more data sets, and selecting a confidence level for the artist from the confidence interval based on a comparison between one or more actual streaming counts obtained prior to the time period and one or more estimated streaming counts obtained prior to the time period.

In some aspects, the techniques described herein relate to a computer-implemented method, where the one or more data sets include at least one of a time series history of a resource allocation for a streaming count of the respective media content items, a set of categories corresponding to the respective media content items, the streaming count of the respective media content items, the historical streaming data for the respective media content items, a geographic location of the set of user accounts, a geographic location of a set of artists associated with the respective media content items, or a frequency of release of media content items associated with respective artists of the set of artists.

In some aspects, the techniques described herein relate to a computer-implemented method, where the account is associated with a first stored balance and a second stored balance, and where the first stored balance corresponds to the estimated resource allocation, and where selecting the confidence level is based on a numerical quantity of withdrawals from the account that exceed the second stored balance over an additional time period.

In some aspects, the techniques described herein relate to a computer-implemented method, where determining the estimated streaming count includes generating, by at least one machine learning model, the estimated streaming count based on inputting the historical streaming data to the at least one machine learning model, where the at least one machine learning model is trained to generate the estimated streaming count using the historical streaming data.

In some aspects, the techniques described herein relate to a computer-implemented method, further including receiving an indication of at least one of an actual streaming count of the media content item or a resource allocation for the actual streaming count of the media content item, and updating one or more parameters of the at least one machine learning model based on the at least one of the actual streaming count of the media content item or the resource allocation for the actual streaming count of the media content item.

In some aspects, the techniques described herein relate to a computer-implemented method, further including outputting, for display at a computing device, an account balance of the account in real-time, where the account balance includes the advance of funds.

In some aspects, the techniques described herein relate to a computer-implemented method, where the historical streaming data includes at least one of streaming data for respective artists of the set of media content items, calendar information associated with the time period, artist information for the respective artists, or a condition related to at least one media content item of the set of media content items.

In some aspects, the techniques described herein relate to a computer-implemented method, where the account is associated with a payment service, and where the payment service and the at least one media content service provider system are associated with an instance of an application.

In some aspects, the techniques described herein relate to a computer-implemented method including determining a confidence level corresponding to an estimated resource allocation from a confidence interval associated with at least one of an artist of a media content item or the media content item, where the estimated resource allocation is based on the confidence level and an estimated streaming count associated with the media content item over a time period, providing instructions to a payment service associated with a media content service provider system to facilitate an advance of funds based on the estimated resource allocation to an account associated with the artist during the time period, where the account is associated with a first stored balance prior to the payment service facilitating the advance of funds and a second stored balance including the at least the portion of the estimated resource allocation, and receiving, via a payment instrument associated with the account, a request to withdraw the first stored balance and at least a portion of the second stored balance.

In some aspects, the techniques described herein relate to a computer-implemented method, further including determining to withdraw the first stored balance and at least the portion of the second stored balance from the account based on at least one of engagement data of a set of user accounts associated with the media content item, the confidence level, or respective data values associated with one or more data sets, where the one or more data sets include at least one of data associated with the media content item from a media content service provider system application, data associated with the media content item from a social platform application, data associated with the artist from the social platform application, or data that indicates additional resource allocation associated with the artist.

In some aspects, the techniques described herein relate to a computer-implemented method, further including outputting, for display at a computing device, the first stored balance and the second stored balance in real-time based on the payment service crediting the account.

In some aspects, the techniques described herein relate to a computer-implemented method, where the confidence level is based on at least one of a time series history of a resource allocation for a streaming count of respective media content items on the media content service provider system, a set of categories corresponding to the respective media content items, the streaming count of the respective media content items, historical streaming data for the respective media content items, a geographic location of a set of user accounts associated with the media content service provider system, a geographic location of a set of artists associated with the respective media content items, or a frequency of release of media content items associated with respective artists of the set of artists.

In some aspects, the techniques described herein relate to a computer-implemented method, where the payment service and the at least one media content service provider system are associated with an instance of an application.

In some aspects, the techniques described herein relate to a system including a processing device, and a computer-readable storage medium storing instructions that, responsive to execution by the processing device, causes the processing device to perform operations including obtaining engagement by a set of user accounts with respective media content items of a set of media content items on at least one media content service provider system, generating historical streaming data for the respective media content items based on the engagement of the set of user accounts with the respective media content items, determining an estimated streaming count of a media content item of the set of media content items over a time period based on the historical streaming data for the respective media content items, determining, based on the estimated streaming count and prior to receiving an actual streaming count, an estimated resource allocation for the artist of the media content item, where the estimated resource allocation corresponds to the time period, and facilitating an advance of funds based on the estimated resource allocation to an account associated with the artist during the time period.

In some aspects, the techniques described herein relate to a system, where the operations further include receiving a request to withdraw at least a portion of the advance of funds from the account, and selectively withdrawing at least the portion of the advance of funds from the account based on at least one of the historical streaming data, a confidence level for the artist, or one or more data sets, where the one or more data sets include at least one of data associated with the media content item from a media content service provider system application, data associated with the media content item from a social platform application, data associated with the artist from the social platform application, or data that indicates additional resource allocation associated with the artist.

In some aspects, the techniques described herein relate to a system, where the operations further include determining, based on one or more data sets, a confidence interval corresponding to the artist, where a size of the confidence interval is based on at least one of a size of the one or more data sets or a variability of respective data in the one or more data sets, and where the one or more data sets include at least one of a time series history of a resource allocation for a streaming count of the respective media content items, a set of categories corresponding to the respective media content items, the streaming count of the respective media content items, the historical streaming data for the respective media content items, a geographic location of the set of user accounts, a geographic location of a set of artists associated with the respective media content items, or a frequency of release of media content items associated with respective artists of the set of artists, and selecting a confidence level for the artist from the confidence interval based on a comparison between one or more actual streaming counts obtained prior to the time period and one or more estimated streaming counts obtained prior to the time period.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
obtaining engagement by a plurality of user accounts with respective media content items of a plurality of media content items on at least one media content service provider system;
generating historical streaming data for the respective media content items based on the engagement of the plurality of user accounts with the respective media content items;
determining an estimated streaming count of a media content item of the plurality of media content items over a time period based on the historical streaming data for the respective media content items;
determining, based on the estimated streaming count and prior to receiving an actual streaming count, an estimated resource allocation for an artist of the media content item, wherein the estimated resource allocation corresponds to the time period; and
facilitating an advance of funds based on the estimated resource allocation to an account associated with the artist during the time period.

2. The computer-implemented method of claim 1, further comprising:
receiving a request to withdraw at least a portion of the advance of funds from the account; and
selectively withdrawing at least the portion of the advance of funds from the account based on at least one of the historical streaming data, a confidence level for the artist, or one or more data sets, wherein the one or more data sets comprise at least one of data associated with the media content item from a media content service provider system application, data associated with the media content item from a social platform application, data associated with the artist from the social platform application, or data that indicates additional resource allocation associated with the artist.

3. The computer-implemented method of claim 2, wherein selectively withdrawing at least the portion of the advance of funds comprises withdrawing at least the portion of the advance of funds from the account based on at least one of the historical streaming data satisfying a streaming threshold value, the confidence level satisfying a confidence threshold value, or respective data values associated with the one or more data sets satisfying at least one threshold value.

4. The computer-implemented method of claim 2, wherein selectively withdrawing at least the portion of the advance of funds comprises:
withholding withdrawal of at least the portion of the advance of funds from the account based on at least one of the historical streaming data failing to satisfy a streaming threshold value, the confidence level failing to satisfy a confidence threshold value, or respective data values associated with the one or more data sets failing to satisfy at least one threshold value; and
outputting, for display at a computing device, a message indicating the withholding of the withdrawal.

5. The computer-implemented method of claim 1, further comprising:
determining, based on one or more data sets, a confidence interval corresponding to the estimated resource allocation, wherein a size of the confidence interval is based on at least one of a numerical quantity of data values in the one or more data sets or a variability of respective data in the one or more data sets; and
selecting a confidence level for the artist from the confidence interval based on a comparison between one or more actual streaming counts obtained prior to the time period and one or more estimated streaming counts obtained prior to the time period.

6. The computer-implemented method of claim 5, wherein the one or more data sets comprise at least one of a time series history of a resource allocation for a streaming count of the respective media content items, a plurality of categories corresponding to the respective media content items, the streaming count of the respective media content items, the historical streaming data for the respective media content items, a geographic location of the plurality of user accounts, a geographic location of a plurality of artists associated with the respective media content items, or a frequency of release of media content items associated with respective artists of the plurality of artists.

7. The computer-implemented method of claim 5, wherein the account is associated with a first stored balance and a second stored balance, and wherein the first stored balance corresponds to the estimated resource allocation, and wherein selecting the confidence level is based on a numerical quantity of withdrawals from the account that exceed the second stored balance over an additional time period.

8. The computer-implemented method of claim 1, wherein determining the estimated streaming count comprises generating, by at least one machine learning model, the estimated streaming count based on inputting the historical streaming data to the at least one machine learning model, wherein the at least one machine learning model is trained to generate the estimated streaming count using the historical streaming data.

9. The computer-implemented method of claim 8, further comprising:
receiving an indication of at least one of an actual streaming count of the media content item or a resource allocation for the actual streaming count of the media content item; and
updating one or more parameters of the at least one machine learning model based on the at least one of the actual streaming count of the media content item or the resource allocation for the actual streaming count of the media content item.

10. The computer-implemented method of claim 1, further comprising outputting, for display at a computing device, an account balance of the account in real-time, wherein the account balance includes the advance of funds.

11. The computer-implemented method of claim 1, wherein the historical streaming data includes at least one of streaming data for respective artists of the plurality of media content items, calendar information associated with the time period, artist information for the respective artists, or a condition related to at least one media content item of the plurality of media content items.

12. The computer-implemented method of claim 1, wherein the account is associated with a payment service, and wherein the payment service and the at least one media content service provider system are associated with an instance of an application.

13. A computer-implemented method comprising:
determining a confidence level corresponding to an estimated resource allocation from a confidence interval associated with at least one of an artist of a media content item or the media content item, wherein the estimated resource allocation is based on the confidence level and an estimated streaming count associated with the media content item over a time period;
providing instructions to a payment service associated with a media content service provider system to facilitate an advance of funds based on the estimated resource allocation to an account associated with the artist during the time period, wherein the account is associated with a first stored balance prior to the payment service facilitating the advance of funds and a second stored balance comprising at least a portion of the estimated resource allocation; and
receiving, via a payment instrument associated with the account, a request to withdraw the first stored balance and at least a portion of the second stored balance.

14. The computer-implemented method of claim 13, further comprising determining to withdraw the first stored balance and at least the portion of the second stored balance from the account based on at least one of engagement data of a plurality of user accounts associated with the media content item, the confidence level, or respective data values associated with one or more data sets, wherein the one or more data sets comprise at least one of data associated with the media content item from a media content service provider system application, data associated with the media content item from a social platform application, data associated with the artist from the social platform application, or data that indicates additional resource allocation associated with the artist.

15. The computer-implemented method of claim 13, further comprising outputting, for display at a computing device, the first stored balance and the second stored balance in real-time based on the payment service crediting the account.

16. The computer-implemented method of claim 13, wherein the confidence level is based on at least one of a time series history of a resource allocation for a streaming count of respective media content items on the media content service provider system, a plurality of categories corresponding to the respective media content items, the streaming count of the respective media content items, historical streaming data for the respective media content items, a geographic location of a plurality of user accounts associated with the media content service provider system, a geographic location of a plurality of artists associated with the respective media content items, or a frequency of release of media content items associated with respective artists of the plurality of artists.

17. The computer-implemented method of claim 13, wherein the payment service and the media content service provider system are associated with an instance of an application.

18. A system comprising:
a processing device; and
a computer-readable storage medium storing instructions that, responsive to execution by the processing device, causes the processing device to perform operations including:
obtaining engagement by a plurality of user accounts with respective media content items of a plurality of media content items on at least one media content service provider system;
generating historical streaming data for the respective media content items based on the engagement of the plurality of user accounts with the respective media content items;
determining an estimated streaming count of a media content item of the plurality of media content items over a time period based on the historical streaming data for the respective media content items;
determining, based on the estimated streaming count and prior to receiving an actual streaming count, an estimated resource allocation for an artist of the media content item, wherein the estimated resource allocation corresponds to the time period; and
facilitating an advance of funds based on the estimated resource allocation to an account associated with the artist during the time period.

19. The system of claim 18, wherein the operations further include:
receiving a request to withdraw at least a portion of the advance of funds from the account; and
selectively withdrawing at least the portion of the advance of funds from the account based on at least one of the historical streaming data, a confidence level for the artist, or one or more data sets, wherein the one or more data sets comprise at least one of data associated with the media content item from a media content service provider system application, data associated with the media content item from a social platform application, data associated with the artist from the social platform application, or data that indicates additional resource allocation associated with the artist.

20. The system of claim 18, wherein the operations further include:
determining, based on one or more data sets, a confidence interval corresponding to the artist, wherein a size of the confidence interval is based on at least one of a size of the one or more data sets or a variability of respective data in the one or more data sets, and wherein the one or more data sets comprise at least one of a time series history of a resource allocation for a streaming count of the respective media content items, a plurality of categories corresponding to the respective media content items, the streaming count of the respective media content items, the historical streaming data for the respective media content items, a geographic location of the plurality of user accounts, a geographic location of a plurality of artists associated with the respective media content items, or a frequency of release of media content items associated with respective artists of the plurality of artists; and
selecting a confidence level for the artist from the confidence interval based on a comparison between one or more actual streaming counts obtained prior to the time period and one or more estimated streaming counts obtained prior to the time period.
